(19) United States
(12) Patent Application Publication
(10) Pub. No.: US 2011/0029420 A1
(43) Pub. Date: Feb. 3, 2011

(54) SYSTEMS AND METHODS FOR A MANAGER TOOLKIT

(76) Inventors: Lisa B. Bianco, Huntington Beach, CA (US); Randall Jones, Carrollton, TX (US); Cheryl L. Patterson, Alameda, CA (US); Ev Shafrir, Mountain View, CA (US)

Correspondence Address: WILSON, SONSINI, GOODRICH & ROSATI, 650 PAGE MILL ROAD, PALO ALTO, CA, 94304-1050, US

(21) Appl. No.: 12/845,524

(22) Filed: Jul. 28, 2010

Related U.S. Application Data
(60) Provisional application No. 61/229,177, filed on Jul. 28, 2009.

(51) Int. Cl. G06Q 10/00

(52) U.S. Cl. 705/32; 705/1.1

(57) ABSTRACT

The invention provides systems and methods for a manager toolkit. The manager toolkit may be a gadget, widget, tool, or any other application that may provide a user with access to payroll or human capital data. The manager toolkit may provide a user with access to a full-sized payroll application or human capital management application. In some embodiments, the manager toolkit may share information with the payroll application or human capital management application. The manager toolkit may include utilities such as a company roster, a resource map, and a timescape.

### CROSS-REFERENCE

This application claims the benefit of U.S. Provisional Application No. 61/229,177, filed Jul. 28, 2009, which application is incorporated herein by reference in its entirety.

### BACKGROUND OF THE INVENTION

Every employer is faced with the regular generation of payroll for its employees. Initially, payroll processing was an arduous manual task, requiring the responsible individual to compute the base pay, applicable taxes, and other deductions for each of the employer's employees. Initially, these calculations were performed by hand. Over time, automated systems have been developed to calculate pay, produce payroll checks, and even to make the automatic payroll deposits into an employee's bank account for employees participating in a direct deposit program. Automated systems have also been developed to deal with overall human capital management.

Prior payroll automation and human capital management systems generally provided an employer with the ability to analyze the payroll or other human capital management in a myriad of respects. Such payroll or human capital management systems are usually provided as software that can be accessed by one or more user. However, in some instances, a user may only need to access one aspect of human capital information or payroll applications or services provided by the software. To access this single function or aspect, a user may have to access large systems or software. This may take up unnecessary computing or processing power. Similarly, a user may have to go through a number of unrelated steps to access a desired function. This may result in unnecessary complexity and time.

Therefore, a need exists for various applications that can function as tools for payroll or human capital management. A further need exists for a manager toolkit, especially for data relating to employees, payroll, or human capital management.

### SUMMARY OF THE INVENTION

The invention provides systems and methods for a manager toolkit for human capital management. Various aspects of the invention described herein may be applied to any of the particular applications set forth below or for any other types of user interfaces and displays. The invention may be applied as a standalone system or method, or as part of an integrated software package, such as a payroll software or human capital management application. It shall be understood that different aspects of the invention can be appreciated individually, collectively, or in combination with each other.

One aspect of the invention may be directed to how the toolkit may relate to other applications or software. For example, a toolkit may share information with one or more related applications. For example, a manager toolkit for human capital management may share payroll and/or human capital data with a full-sized payroll application. The toolkit may communicate with the full-sized payroll application. An aspect of the invention may provide a human capital management system comprising a toolkit for providing access to human capital or payroll data, the toolkit including a resource map and a time-related display of human capital or payroll events, wherein the toolkit is stored in memory.

Another aspect of the invention may be directed to a user interface for the manager toolkit. In some embodiments, a toolkit may include a cover page providing access to one or more utilities, such as a company roster, resource map, and timescape. The toolkit may enable a user to access desired human capital and payroll data through the use of filters. The filters may be related to geographic and time-based information, as well as any desirable contact criteria.

A user interface for human capital management may be provided in accordance with an aspect of the invention, wherein the user interface may comprise a toolkit for accessing a human capital or payroll database to provide quick access to human capital or payroll data, wherein the toolkit accesses a customized subset of the data stored in the human capital or payroll database for individualized purposes.

A further aspect of the invention may provide a method for human capital management comprising: displaying, on a video display, a toolkit for accessing a human capital or payroll database, thereby providing access to human capital or payroll data; and accessing, via the toolkit, a customized subset of the data stored in the human capital or payroll database for individualized purposes.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE FIGURES

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows a system with client devices interacting with a server over a network.

FIG. 2A shows a manager toolkit and a software program on the same system.

FIG. 2B shows another implementation of a manager toolkit and a software program.

FIG. 2C shows an implementation of a toolkit and a software program accessing the same information.

FIG. 3A shows an example of a manager toolkit cover page format.

FIG. 3B shows an example of a toolkit cover page.

FIG. 3C shows another example of a toolkit cover page.

FIG. 4 shows an example of a utility template screen.

FIG. 5A shows an example of a company roster page format.

FIG. 5B shows an example of a company roster page.

FIG. 5C shows an example of a workforce roster page.

FIG. 6A shows an example of a contact card format.

FIG. 6B shows an example of a contact card view.

FIG. 7A shows an example of a resource map view format.

FIG. 7B shows an example of a resource map view.

FIG. 7C shows an example of a map view.

FIG. 8A shows an example of a timescape layout for the toolkit.

FIG. 8B shows an example of a timescape for the toolkit.

FIG. 8C shows an example of a toolkit timescape.

FIG. 8D shows an example of an event detail display.

### DETAILED DESCRIPTION OF THE INVENTION

While preferred embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

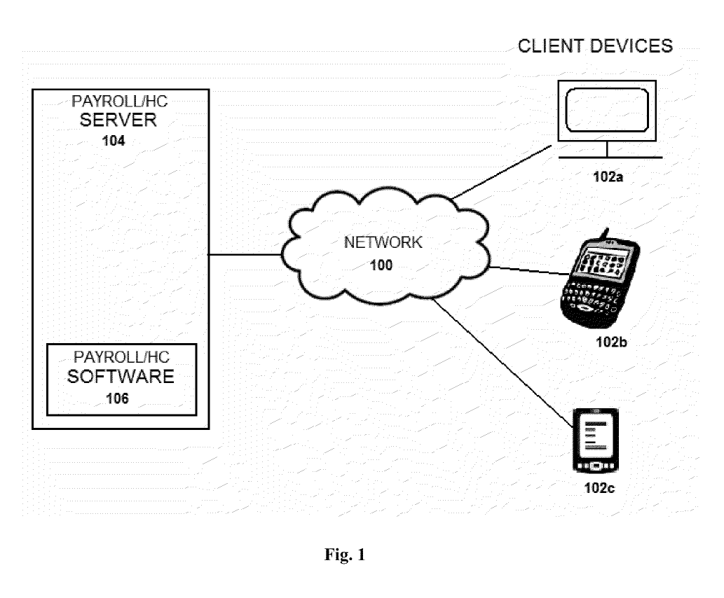

A user interface provided in accordance with the invention herein may be displayed across a network 100 such as the Internet. For example, as shown in FIG. 1, an implementation may include a client computer, or other client device 102a, 102b, 102c such as a smartphone, comprising a video display with at least one display page comprising data. The data may include human capital management data, which may include data such as payroll data (including items such as wage compensation and benefits), workforce planning, recruitment, induction/orientation, skills management, training and development, personnel administration, time management, travel management, personnel cost planning, or performance appraisal, or human capital data, which may include employee data, employee contact information, employee location, employee skills or so forth. Such payroll or human capital data may relate to employees, personnel, management, or other people or entities associated with a company or organization. Such payroll or human capital data may relate to paychecks that are provided to individuals. Such payroll or human capital data may relate to physical/geographic locations associated with individuals and/or the company or organization.

Human capital management and payroll data may include data that can be person and time dependent. Such data may be heterogeneous across different businesses and a human capital management outsourcing software may advantageously display human capital management data. Any discussion herein relating to payroll data, human capital management data, or any type of human capital data may relate to one another. Thus any discussion of human capital data management or management may apply to human resources, payroll, and human capital management data, and vice versa. Similarly, any discussion of any of the aforementioned types of data may relate to any other types of aforementioned data. Furthermore, any discussion herein may also be applied to any other types of data.

Video displays may include devices upon which information may be displayed in a manner perceptible to a user, such as, for example, a computer monitor, cathode ray tube, liquid crystal display, light emitting diode display, touchpad or touchscreen display, and/or other means known in the art for emitting a visually perceptible output. Video displays may be electronically connected to a client computer according to hardware and software known in the art.

In one implementation of the invention, a display page may include a computer file residing in memory which may be transmitted from a server over a network to a client computer, which can store it in memory. A client computer may receive non-transitory computer readable media, which may contain instructions, logic, data, or code that may be stored in persistent or temporary memory of the client computer, or may somehow affect or initiate action by a client computer. Similarly, one or more servers 104 may communicate with one or more client computers or other devices 102a, 102b, 102c across a network 100, and may transmit computer files residing in memory. The network, for example, can include the Internet or any network for connecting one or more clients to one or more servers.

Any discussion of a client computer or device may also apply to any type of networked device, including but not limited to a personal computer, server computer, or laptop computer; personal digital assistants (PDAs) such as a Palm-based device or Windows CE device; phones such as cellular phones, smartphones, or location-aware portable phones (such as GPS); a roaming device, such as a network-connected roaming device; a wireless device such as a wireless email device or other device capable of communicating wireless with a computer network; or any other type of network device that may communicate over a network and handle electronic transactions. Any discussion of any device mentioned may also apply to other devices.

At a client computer, the display page may be interpreted by software residing on a memory of the client computer, causing the computer file to be displayed on a video display in a manner perceivable by a user. The display pages described herein may be created using a software language known in the art such as, for example, the hypertext mark up language (“HTML”), the dynamic hypertext mark up language (“DHTML”), the extensible hypertext mark up language (“XHTML”), the extensible mark up language (“XML”), or another software language that may be used to create a computer file displayable on a video display in a manner perceivable by a user. Any computer readable media with logic, code, data, instructions, may be used to implement any software or steps or methodology. Where a network comprises the Internet, a display page may comprise a webpage of a type known in the art.

A display page according to the invention may include embedded functions comprising software programs stored on a memory, such as, for example, VBScript routines, JScript routines, JavaScript routines, Java applets, ActiveX components, ASP.NET, AJAX, Flash applets, Silverlight applets, or AIR routines.

A display page may comprise well known features of graphical user interface technology, such as, for example, frames, windows, tabs, scroll bars, buttons, icons, menus, fields, and hyperlinks, and well known features such as a “point and click” interface. Pointing to and clicking on a graphical user interface button, icon, menu option, or hyperlink also is known as “selecting” the button, icon, option, or hyperlink. Additionally, a “point and gesture” interface may be utilized, such as a hand-gesture driven interface. Any other interface for interacting with a graphical user interface may be utilized. A display page according to the invention also may incorporate multimedia features.

A user interface may be displayed on a video display and/or display page. A server and/or client computer may have access to human capital management or payroll software. A user interface may be used to display or provide access to human capital management or payroll data.

For example, a user interface may be provided for a web page or for an application. An application may be accessed remotely or locally. A user interface may be provided for a gadget, widget, tool, plug-in, or any other type of object, application, or software.

Any of the client or server devices described may have tangible computer readable media with logic, code, or instructions for performing any actions described herein or running any algorithm. The devices with such computer readable media may be specially programmed to perform the actions dictated by the computer readable media. In some embodiments, the devices may be specially programmed to perform one or more tasks relating to payroll or human capital management.

I. Toolkit Architecture

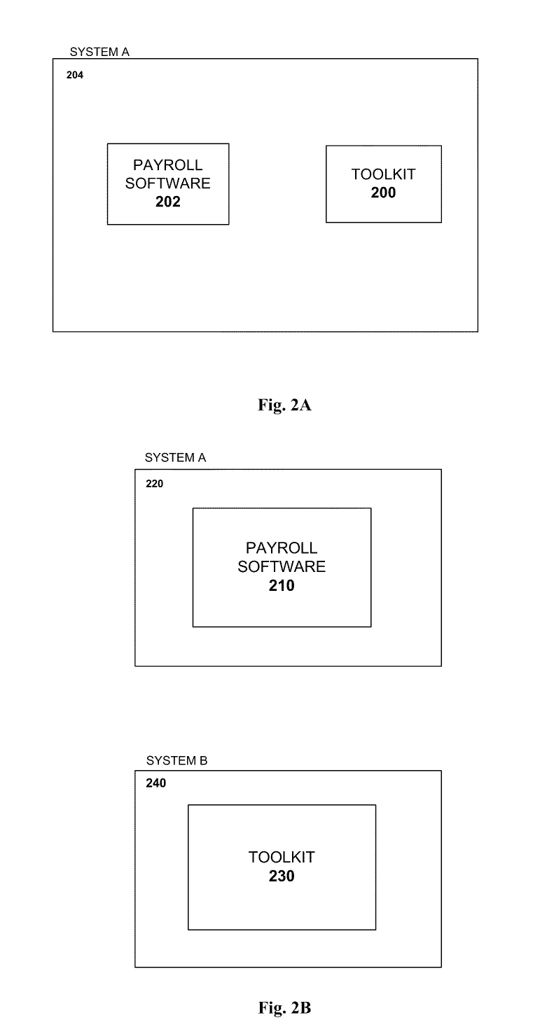

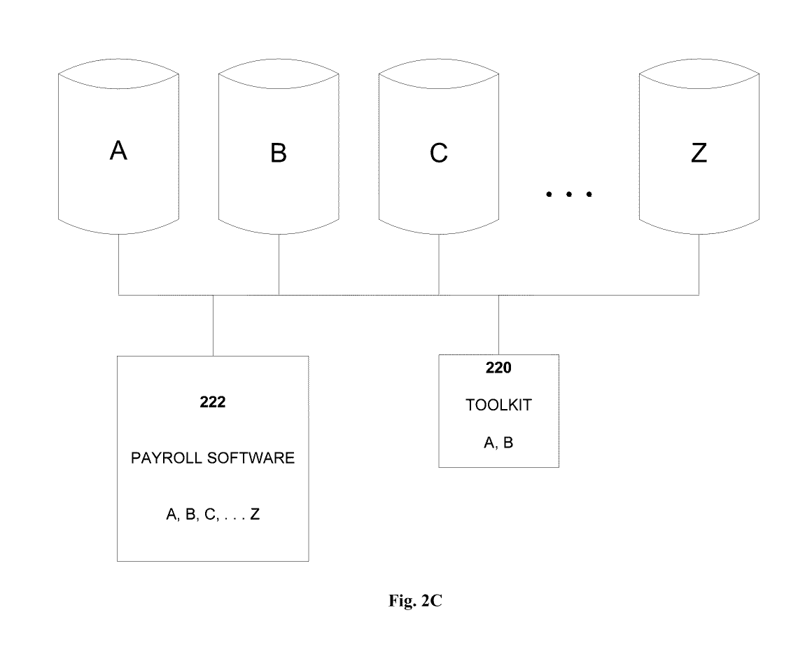

In accordance with one aspect of the invention, FIG. 2A shows an example a manager toolkit 200 and a software program 202 on a system A 204. A toolkit may be a standalone application, or may be part of a larger application or software, such as payroll software. The manager toolkit may communicate with the software program. In some implementations, the toolkit application may communicate with a larger payroll software or share data or information with the payroll software. Any discussion herein of a manager toolkit may apply to any other toolkit for any other type of payroll or human capital data related application, or application relating to any other type of data. Furthermore, any discussion of a toolkit herein may apply to any gadget, widget, tool, plug-in, or any other type of dynamic content, object, application, or software. See e.g., U.S. Pat. No. 5,896,532, which is hereby incorporated by reference in its entirety. A toolkit may be a miniature object that may offer dynamic content that can be placed on any page of the web, phone, or computer desktop environment. The toolkit may be utilized by a roaming device, such as a network-connected roaming device such as a PDA, GPS, or any phone device. The manager toolkit may provide a smaller application (e.g., gadget, widget, tool, object, program) that may not require the complexity, power, or memory of a full-sized payroll application. The toolkit may enable a user to interact with payroll or management data, and may provide a graphical user interface for such interaction.

In some instances, the toolkit and a payroll software may reside on the same machine, as shown in FIG. 2A. For example, system A 204 may be a client computer, which has the toolkit 200 and payroll software 202 residing on its memory. In another example, system A may be a server, which has the toolkit and payroll software residing on its memory, which may be accessed by one or more client computers or other devices over a network. System A may be any type of network device.

In another embodiment, as shown in FIG. 2B, a payroll software 210 or program may reside on a first system A 220, and a manager toolkit 230 may reside on a second system B 240. System A and system B may be any combination of network devices. For example, system A may be a server and system B may be a client computer. A server computer may have a software program residing in memory. A client computer may have a manager toolkit application residing in local memory. In some instances, the manager toolkit may have been downloaded to the client computer from the server. The toolkit application on the client computer may communicate with the payroll software program on the server. In some instances, the toolkit application may primarily function as a standalone application, but may communicate with the server application in particular situations.

Communication between system A and system B may occur over a network or directly. Any communications may be via a wired connection or may occur wirelessly. Any number of systems may be provided, including 1, 2, 3, 4, 5, 6 or more systems.

The toolkit may share data with the payroll software program or another application. For example, the toolkit and the payroll software program may access the same payroll or human capital data. In some instances, the data may be stored in one or more databases. The data may be stored locally with the payroll software, locally with the manager toolkit, or may be stored at another system or memory (e.g., server or client computer). The data may or may not be divided and stored on different memories.

FIG. 2C shows an example of a toolkit 220 and software program 222 sharing the same data. For example, data may be stored on a plurality of databases (e.g., A, B, C, . . . Z). These databases may be stored anywhere. For example, they may be stored on the same system or on different systems. In one embodiment, a full-scale software program, such as a payroll software program may be configured to have access to all or most of the data in the databases (e.g., A, B, C, . . . Z). A toolkit may access data in the same set of databases. In some instances, a toolkit may access less data than is accessed by the software program. For example, a toolkit may only access the type of data stored in databases A and B if the data is divided in that manner. Or the toolkit may access bits of data from one, some, or any of the databases. Depending on the function of the toolkit, the toolkit may only need to access certain types of data. For example, both the software program and the toolkit may access data relating to an employee's personal information from the same database, but the toolkit may not require information about the employee's 401(k) distributions. A toolkit may have a specialized use relating to a particular subset of the data. The toolkit may or may not be able to access information that is not accessed by the software program.

In any of these situations, the software program and the toolkit may be stored on the same system or on different systems. Similarly, the databases may be stored on the same system or different systems. Any components that may be stored on different systems may communicate with one another over a network, including but not limited to the Internet or local area network. In one example, a payroll software program may be stored on a server and may be accessed by a client computer or any other type of device. A toolkit may reside on a client computer, PDA, or any other type of device, and the databases may be stored on one or more server.

Any form of interaction across one or more systems may be provided, including communication between various applications and/or sharing of data. See e.g., U.S. Patent Publication No. 2007/0208637, U.S. Patent Publication No. 2005/0278202, U.S. Pat. No. 6,094,655, which are hereby incorporated by reference in their entirety.

In some embodiments, the manager toolkit may take up less memory than the payroll software program. Thus, the manager toolkit may have a smaller footprint than the payroll software program. In order to access information in the manager toolkit, there may or may not be fewer selections or pages a user needs to go through. Similarly, the manager toolkit may have fewer pages and/or features than the payroll software program. In some instances, the manager toolkit may require less processing or computing power than the payroll software program. In some instances, the manager toolkit may operate more quickly than the payroll software program.

Access to a manager toolkit may be provided as a pre-existing application along with the payroll software. As discussed previously, a manager toolkit may be downloaded to a client computer. A manager toolkit may be provided to a client computer in any manner known in the art, including being provided through a memory device such as a CD-ROM, diskette, or memory key. Or a manager toolkit may run remotely, but be accessible by the client computer.

In some implementations, a manager toolkit may be created by any technique known in the art. For example, Google allows users to create a gadget that may operate in a Google environment and may be designed or created using Google tools. In some implementations, a manager toolkit may be a gadget operable to run in an existing environment, such as a payroll software toolbar, Google Desktop, My Yahoo!, any protected corporate intranet, or any public web site.

A manager toolkit may be configured to provide time-related information. The toolkit may utilize a clock in order to provide the time-related information. In some embodiments, the toolkit may utilize the clock of the system that the toolkit is residing on. For example, if the toolkit is residing on a client computer, the toolkit may utilize the local client computer clock. If the toolkit is residing at a server, the toolkit may utilize the server clock. In other embodiments, the toolkit may utilize the clock of another system, e.g., the toolkit may be residing on a server and may utilize a client computer clock or vice versa. In some embodiments, the toolkit may utilize the clock of the system where a payroll software or other larger application may reside. The toolkit may utilize a clock to determine the time at the client computer that is accessing the toolkit, or the time for the user that is accessing the toolkit.

Similarly, a manager toolkit may be configured to interact with or utilize other applications. Such applications may or may not be closely related to the manager toolkit or related software application. For example, the manager toolkit may utilize pre-existing map programs. The manager toolkit may be sharing data with any number or types of applications.

A manager toolkit may interact with other toolkits, gadgets, widgets, applications, tools, objects, or programs. In some embodiments, one or more of these tools may share access to one or more database, or may have access to common information, which may be stored in memory.

A manager toolkit may be configured to provide employee or payroll information. A manager toolkit may be directed to an employee manager. An employee manager may be someone responsible for approving time cards, or assigning employees to shifts. Although an employee manager may be provided, other users may also be provided, such as employees, payroll administrators, or any other managers, employees, or persons involved in human resources. A user may have access to different parts of a manager toolkit depending on the type of user. Alternatively, different types of users may have access to different types of manager toolkits. Employee information provided may relate to the assigning of daily, weekly, ongoing shift assignments, new hire information, contact information, location information, time-related information such as employee birthdays or annual employee anniversaries, or payroll information for the employees.

Any of the description herein relating to a manager toolkit may also apply to an employee toolkit, or any other person toolkit, and vice versa. Any form of user interface may be provided for the employee toolkit. In some embodiments, an employee toolkit may utilize other toolkits, gadgets, widgets, applications, tools, objects, or software, such as the manager toolkit, map applications, clock applications, or a full-sized payroll application. In some instances, a person toolkit may be provided for any person in a human capital management system. Thus, a toolkit may be accessed by anyone involved in human capital management, whether or not they are a manager or employer and any discussion for any toolkit accessed by any user may apply to a toolkit that can be accessed by any other user.

A. Employee Toolkit

In some embodiments, only a manager may access a manager toolkit. In other embodiments, employees may have partial or complete access to a manager toolkit. In some embodiments a separate employee interface may be provided. In some embodiments, a separate employee toolkit may be provided. In one example, vacation hour entries and approvals may be initiated by managers or directly by employees. In some embodiments, employees may be able to access an employee toolkit interface to enter vacation hours or other payroll related data, or may be able to access an employee interface for the manager toolkit. Similarly, personal information records may be updated by employees or managers. Any formal employee request may be initiated using the system (e.g., leave, transfer, raise, expense, shift change, advance, personal record change, and so forth). The manager toolkit may operate universally.

1. If Non-Manager Users may Access a Manager Toolkit:

A manager toolkit may provide two-way interactions. Such interactions may enable data collection from managers and multi-party workflows. A toolkit user interface may enable various user interactions with payroll and human capital data. For example, small forms may flip-open inside toolkit windows for focused data entry. Such small forms may overlay the existing interface, or may be opened in other windows or tabs. Links may be provided that may connect to full application pages (e.g., new browser windows or tabs) for larger tasks. In some instances, such links may provide a user with access to a full-fledged payroll software. A manager toolkit may enable managers to enter payroll worksheet hours directly into toolkit window or to a linked single-page worksheet for only their group of employees. Or a manager toolkit may enable an employee to enter select types of payroll information. In some embodiments, any information entered by an employee may be approved by a manager.

HR notes and memos may be recorded, tracked, and secure in a manager toolkit. Such notes and memos need not be email based. The interactions of managers and employees with a manager toolkit may allow a complex multi-party request workflow. A manager may view an entry, approve the entry, cause the entry or other data to be routed, modify entered data, enter the manager's own data, sign-off, or any other actions.

2. If a Separate Employee Toolkit is Provided:

An employee self service toolkit may allow information to be delivered with significantly smaller screen footprints than a full window application, such as a full sized payroll application. An employee toolkit may enable an employee to run a smaller application that may not require the computing power or memory of a full-sized payroll application.

In one implementation, an employee toolkit may be a simple view-only information toolkit that may deliver focused information queries to the employee. Two-way request and approve interactions may also be possible with mini-sized request templates. Some examples of employee requests for information and actions may be provided as follows:

1. “Show me my last paycheck summary. How much was deposited?”, link to download full check

2. “How much vacation do I have?”, display remaining vacation

3. “I want to request a 2-day vacation”, flip open a mini-size request card

4. “I need to stop my 401 (k) contribution ASAP”, flip open a mini-size before/after modify-card

5. “I moved”, “I have a new cell phone number”, “I have a new email”, flip open mini-size personal contact card

II. User Interface

Another aspect of the invention provides user interfaces for a toolkit. In some embodiments, a toolkit user interface may not take up the whole screen of a video display. For example, in some embodiments of the invention, a user interface width may be about a quarter of the width of the screen. In other embodiments, any dimensions may be provided for the toolkit user interface. For example, the user interface may be a portion of the video display or screen size, such as having a width about one eighth of the screen width, one sixth of the screen width, one fifth of the screen width, one quarter of the screen width, one third of the screen width, one half of the screen width, or being a full screen. In some embodiments, the user interface may have an absolute size (e.g., determined by pixel dimensions) so that the toolkit user interface size may vary in relation to screen size. In some embodiments, multiple screen sizes may be selected such that a user may be able to toggle between two or more screen sizes as desired. In some embodiments, for a smaller screen, such as for a PDA or mobile phone, it may be desirable for the toolkit user interface to be fullscreen. The size of the toolkit screen may depend on the device on which it is displayed. A default size may be selected based on the device on which the toolkit is displayed.

A toolkit user interface may be a separate window. In some embodiments, the window may be designed to remain on top while the toolkit is being utilized. In other embodiments, the toolkit window may fall behind other windows of a desktop or any operating system environment.

A toolkit user interface may provide access to data in one or more different manners. Providing access to data may include any activity that may lead to creating, using, modifying, or viewing the data. For example, a toolkit user interface may provide visual access to data by displaying the data within the screen. A user interface may also provide access to data by providing a link or button or any other option that may enable a user to see the data in another view. Providing access to data may also include allowing a user to perform a function with the data, such as creating a new data object, editing existing data, or printing an item using the data. The various parts of the toolkit user interface do not need to provide access to data in the same manner or format.

A manager toolkit may have a user interface with one or more pages. Some examples of pages that might be displayed for a toolkit are: a cover page, a company roster page, a resource map page, and a timescape page. Additional pages, such as contact cards, event cards, pages to provide additional detail, or pages to accept data or updates, may be provided.

A. Cover Page

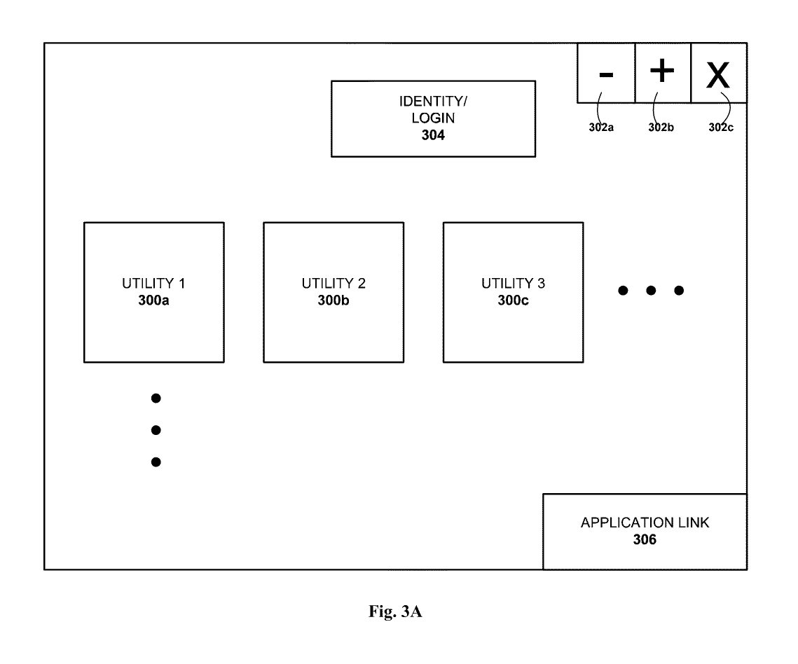

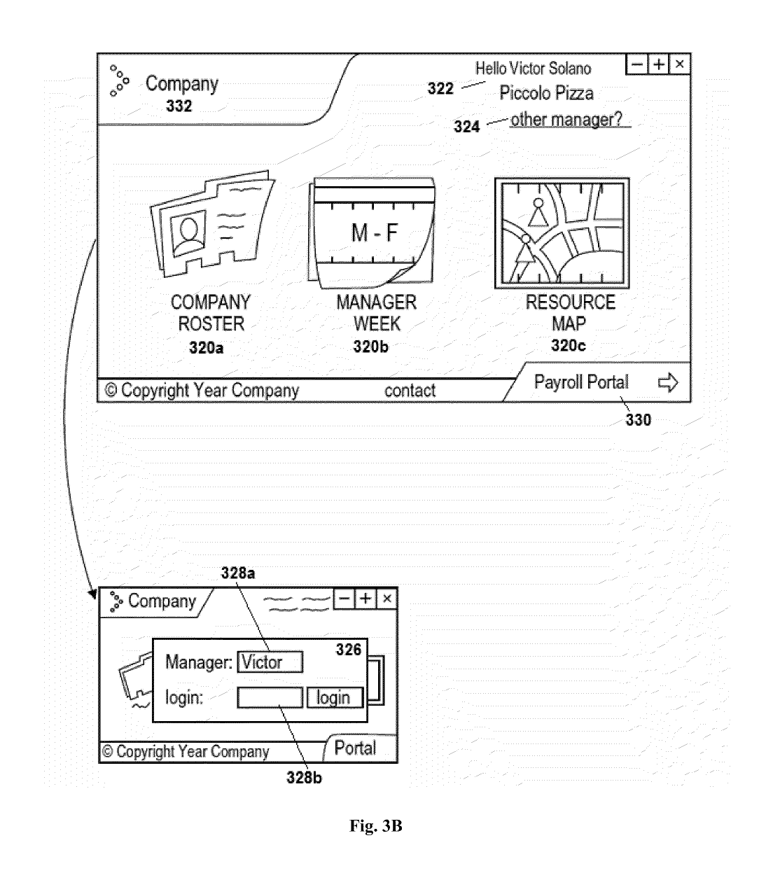

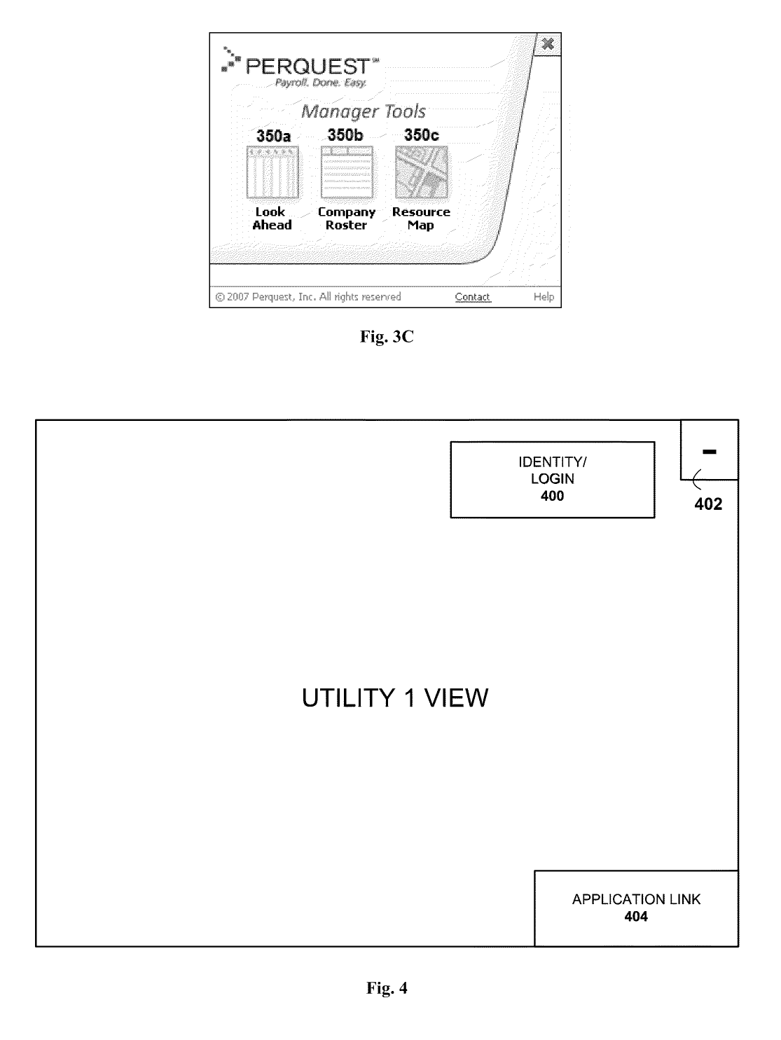

FIG. 3A shows an example of a manager toolkit cover page format. In some embodiments, a toolkit cover page may be a default starting page for a manager toolkit. In other embodiments, a toolkit cover page may or may not be displayed in a manager toolkit.

A toolkit cover page may show available utilities. Any number of utilities 300a, 300b, 300c may be displayed on the toolkit cover page. For example, one, two, three, four, or more utilities may be displayed. These utilities may be displayed in any format, including icon format, list format, or chart format. In a preferable embodiment, a utility icon and label may be provided. The icons may vary depending on the utility. For example, as shown in FIG. 3B, a utility icon for a company roster 320a may show a file folder, a utility icon for a manager week 320b may show a calendar, and a utility icon for a resource map 320c may show a map. The utility icons may look like PDA style ‘application’ icons for each toolkit function. The utility icons may be arranged in any manner. For example, the icons may be arranged in a row, a column, a wheel, a web, or in an array. A utility icon and/or label may be displayed for each toolkit function.

A user interface for a manager toolkit may include one or more window controls 302a, 302b, 302c. For example, one or more window controls may be provided that may enable a user to close a user interface (e.g., by showing an [×]), fold a user interface (e.g., by showing a [−]), maximize/change display size of a user interface (e.g., by showing a [+]), or any other functions, such as scrolling through a user interface, or moving to a previous or next window. Window controls may be displayed adjacent to one another, or alternatively, may be displayed in different parts of a toolkit user interface. In some embodiments, they may be displayed at or near a corner, such as an upper right corner, lower right corner, upper left corner, or lower left corner.

A manager toolkit cover page may also include an identity/login region 304. The toolkit user interface may include a region of the user interface display. A region may have a defined geometric shape, such as a rectangle. In another example, a region may have any defined shape, even if it irregular. A shape may be defined by some sort of visual cue, such as a border or color change. A region need not have a visual indication of the region's boundaries. Alternatively, the region itself may not have a defined shape, but may include an area which may provide access to data. An identity/login region may display user recognition and/or allow a user to log into the toolkit.

A toolkit may recognize a user. In some instances, the user or client computer may be recognized if the client computer has previously accessed the manager toolkit. A user or client computer may be recognized using a cookie-memory, flash object, plug-in, access token, or any other type of memory that may identify a client computer or user to the toolkit. The identity/login region may display the name of a recognized user. In some embodiments, the name of the company associated with the recognized user may be displayed. An option may be provided for a user to login, in the event that the user is not the user identified by the recognized username. This may be done through an ‘other manager’ link. If the user is not recognized, the identity/login region may ask the user to login.

In some embodiments, clicking an option to login 322, or an ‘other manager’ link 324 may create a login interface. A login interface may be displayed in any way known in the art. For example, a login interface may be displayed as a mini-login screen 326 that may overlay the toolkit interface (see, e.g., the bottom portion of FIG. 3B). A mini-login screen may overlay a part of or all of the toolkit interface.

Alternatively, the login interface may be displayed in a separate window, tab, or may be displayed adjacent to the toolkit interface.

A login interface may include one or more fields 328a, 328b. For example, a login interface may include a field for a user to enter a username, and a field for a password. In some embodiments, a field may be pre-populated with a default value. For example, the username field may be pre-populated with a username. In some embodiments, such as when a user selects an ‘other manager’ option, the field may be defaulted as blank.

In some embodiments, a login interface may appear when a user selects a utility. A login interface may appear in any manner, such as a mini-login screen overlaying the toolkit interface. In a preferable embodiment of the invention, the login interface may include a username field with a default username value, if the toolkit recognizes the user. In some embodiments, one or more fields may be defaulted with one or more values from a cookie-memory, flash object, plug-in, access token, or any other type of memory that may identify a client computer or user to the toolkit. In other embodiments, a username field may not automatically be populated with a default value. In some embodiments, other fields, such as a password field, may also be automatically populated with a default value. This default value may also come from any type of memory that may identify a client computer or user to the toolkit as discussed. In some embodiments, a default value for a password field may not be provided.

In some embodiments, a user may select an option that may enable particular login fields to be automatically populated and others to not have a default value. A user may select an option whether a login interface occurs when a user selects a utility. For example, a default may be for a login interface to appear whenever a user selects a utility. A user may also be able to select an option such that once a user is recognized by the toolkit, or logs in once, no login interface needs to appear when a user selects a utility.

In a preferable embodiment of the invention, an authenticated view of a manager toolkit cover page may look the same as an unauthenticated view. The same may hold true for any other pages. In alternate embodiments, an authenticated view of a manager toolkit cover page and/or any other subsequent pages may look different from an unauthenticated view. For example, additional options or features may be visible in an authenticated view. In another example, information about the user (e.g., user personal info, or user account info) may be visible.

A manager toolkit user interface may include an application link 306, 330. For example, an application link may be a link to a full-sized payroll application, or any other type of full-sized software application. Or an application link may provide access to any other type of payroll, human capital management, or any other type of application, which may or may not be full-sized. Selecting an application link may launch a payroll portal in a new tab or window, or overlaying the toolkit interface. In some embodiments, the payroll portal may appear with a full screen user interface. The payroll portal may appear on the same device or another device. The payroll portal may be locally or remotely accessed.

In some embodiments, an application link may be displayed in a region of the user interface. In preferable embodiments, the application link may be displayed in the same region of the user interface regardless of which screen of the manager toolkit is being displayed. For example, an application link may be displayed at a corner, such as a lower right corner, and may appear at the same corner for each of the user screens that are displayed, i.e., when different utilities or tools are selected.

FIG. 3B shows an example of a toolkit cover page. A toolkit cover page and/or any subsequent pages may include a company logo 332. In some embodiments, the entity that owns, distributes, operates and/or developed the manager toolkit may own, distribute, operate, or have developed a payroll or human capital management application or service. Alternatively, different entities may be involved with the manager toolkit and payroll or human capital management application or service or in owning, distributing, operating, and/or developing the toolkit and/or payroll or other services. The manager toolkit may be branded with the logo of an entity involved with the manager toolkit and/or an entity involved with the payroll. In some embodiments, the logo may appear in the same part of the user interface for the cover page and any subsequent pages, such as a corner (e.g., upper left corner). In other embodiments, the logo need not appear in the same part of the user interface. In some instances, the logo provided on the cover page may have the same or similar appearance to logos that may appear in subsequent pages.

In some embodiments, the manager toolkit may have a toolkit title and/or toolkit value tagline. In some embodiments, the title and/or tagline may be published in a toolkits directory (e.g., Google Gadgets directory). Some examples of titles or taglines that may be used may include, but are not limited to, “Easy Manager”, “Manager Window”, “ManagerScape”, “MyGroup”, “GroupView”, or “ManagerView”.

FIG. 3C shows another example of a toolkit cover page. As discussed previously, a toolkit cover page may include one or more utility icons 350a, 350b, 350c, which may be provided for various features of the toolkit. In one embodiment, a manager toolkit may have a company roster feature, a manager week feature, and a resource map. Similarly, a manager toolkit may have a look ahead feature, a company roster feature, and a resource map. Any other features that may be useful for management of any other data, including payroll data, employee data, or human capital management data may also be provided.

B. Utility Page

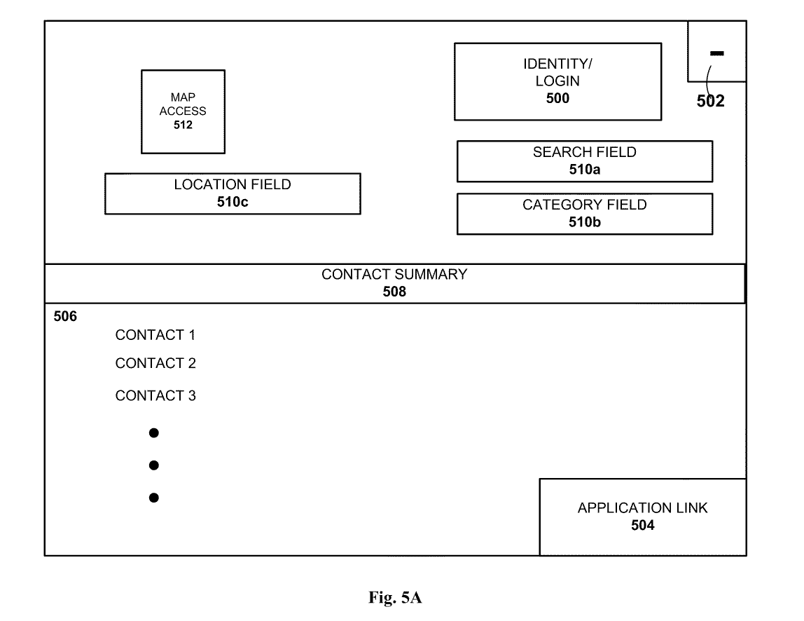

Selecting a utility may result in the toolkit interface displaying a utility page. FIG. 4 shows an example of a utility template screen. For example, any display relating to the particular selected utility may be displayed. In some embodiments, the selected utility display may overlay the cover page. In some alternate embodiments, the selected utility display may be opened in another tab or window, or be adjacent to the cover page.

In some embodiments, closing the utility display may return the user interface to the cover page. In other embodiments, closing the utility display may close the manager toolkit user interface. In some embodiments, different controls may be provided to close the selected utility view to return to the cover page and to close the manager toolkit interface.

In some embodiments, features such as an identity/login region 400, window control 402, and/or application link may be displayed 404. For example, such features may be displayed in the same region or manner in which they were displayed for another page, such as a toolkit cover page.

In some embodiments, utility view pages may only provide specified window controls. For example, the selected utility view pages may only include a window control that may fold a window, while a toolkit cover page may include multiple window controls, such as closing a window, folding a window, and maximizing a window.

C. Company Roster

During an implementation of a manager toolkit, a company roster utility may be selected from a cover page. In some other embodiments, a company roster page may be a starting page for a manager toolkit.

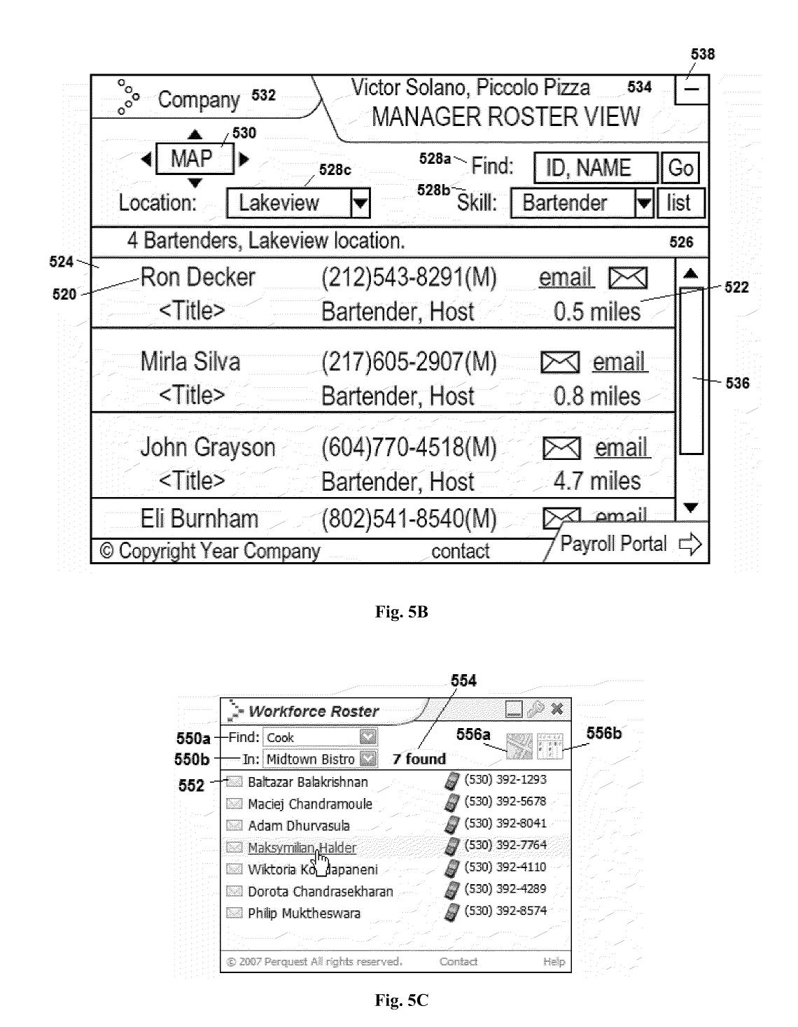

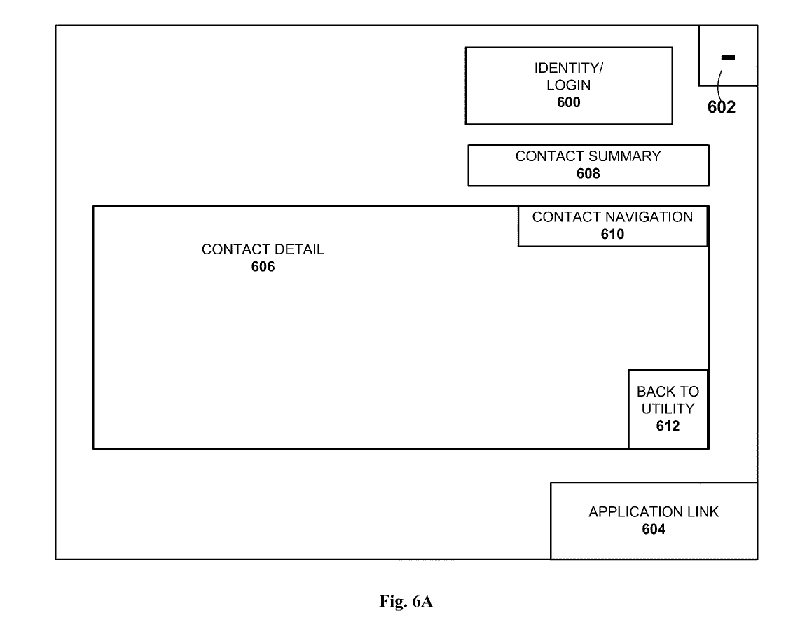

FIG. 5A shows an example of a company roster page format. As discussed previously, features such as an identity/login region 500, window control 502, and/or application link 504 may be displayed. These features may be displayed in any manner, including but not limited to the same manner in which they were displayed in any other page, such as the toolkit cover page.

1. Contact List

A company roster view for a manager toolkit may display a company directory. In a preferable embodiment, a full company directory may be provided. One or more managers may be able to access the full roster across locations. In some implementations, the company roster view may include people on the company roster, not a general contact list. In alternate embodiments, the company roster may be a contact list. For instance, the company roster view may include any contacts that may be useful for human capital or employee management. Or the company roster view may include any contacts that may be relevant for payroll purposes. For instance, the company roster may include employees of the company.

A company roster view may include a list of contacts. The list of contacts may be provided in a contact region 506. The list of contacts may be displayed in any manner. For example, contacts may be provided as a vertical list. In other embodiments, contacts may be provided as a horizontal list, in a diagonal manner, or any other configuration that may show the list of contacts. The contacts within the contact list region may be displayed such that they form a linear display such that the items are all at the same level, e.g., Contact 1, Contact 2, Contact 3, etc. The contacts may be displayed in a vertical linear display, a horizontal linear display, or linear display or any orientation.

In other implementations, the contacts in the contact list region may be arranged into groupings or have some form of organization that may be visually apparent. For example, there may be categories of contacts, and the contacts may be displayed below the categories and indented, or have any other visual indication that the contacts are associated with a contact category. For example, a category may be based on a skill set, an employee group, a location, cost effectiveness or any other categorization of a contact. In some embodiments, a contact list region may initially display a list of contact categories and it may be possible to drill down into a contact category to get access to the contacts within the contact category. One example of drilling down may include a drill down list where contact categories with one or more contacts may include a visual indicator that a user may select, which will allow the contacts within the contact category to appear in the list below the contact category. Thus, contacts within a contact list region may be displayed in a manner such that they are or are not associated with a contact category in a visual manner, and such that contacts may or may not be hidden at a user's discretion.

In an initial view, the contacts and/or groups of contacts may be displayed in any order. They may be presented according to any criteria, e.g., alphabetically, location, skills, etc.

In some embodiments, all contacts that fit within specified criteria may be displayed. In other embodiments, only a desired number of contacts that fit within the specified criteria may be displayed. For example, the company roster page may be configured such that only the top three results with the specified criteria may be displayed. In some instances, a user may select the criteria that ranks the contacts. For example, the contacts may be ranked first by proximity to a specified location. In another example, the contacts may be ranked first by cost effectiveness. In some embodiments, only a single contact may be displayed.

As shown in FIG. 5B, a contact may include the contact name 520, as well as selected information 522 about the contact. For example, a contact may also include the contact's title, telephone information, skillset, email address, and distance from the present location. Other examples of contact information may include location, all phone numbers, department, employee group, pay scale, or any other information related to the contact. In some embodiments, the information about the contact may be below or beside a contact name. A contact may be provided within a contact region 524. For example, for a vertical contact list, a contact region may form a horizontal bar.

In some embodiments, the information about the contact may provide access to a tool to provide access to the contact. For example, a link with ‘email’ may be provided, such that selecting the email option may allow the user to email the contact. For example, an email interface may appear in another window or tab, or overlaying the existing user interface. Similarly, a link showing the distance of the contact from the selected location may be provided, such that selecting the distance link may provide access to a map with the contact's location. For example, a map interface may appear in another window or tab, or overlaying the existing user interface.

A contact summary 508, 526 may be provided. A contact summary may include summarizing information about the contacts provided in the contacts region. The contact summary may include information, such as the total number of contacts, the number of contacts with a particular title, skill set, or location. In some embodiments, the contact summary may also include information relating to a contact category. The contact category may also include selected information, such as a selected location. The contact summary may be displayed in a contact summary region. In some instances, the contact summary region may carry over between pages.

2. Contact Fields

Information relating to contacts, contact categories, or locations may be provided by one or more field 510a, 510b, 510c. For instance, as shown in FIG. 5A, a search field, a category field, and a location field may be provided in a company roster view. The fields may be provided on any area or region of the user interface. In a preferable embodiment, the search field and category field may be adjacent to one another. In some embodiments, they may be vertically adjacent to one another. The various fields may be provided in an area outside of the contact summary and contact list region.

A search field 528a may enable a user to search for a contact or employee by name. For example, the search field may enable a user to type in a name, and the company roster/contact list may be searched for the entered name. In some embodiments, the user may enter other identifying information, such as an identification number, or any other unique or almost unique identification for the contact.

In some embodiments, entering the information in the search field and selecting the option to search may cause the contact list to only display contacts that match the identification in the search field. For example, if the name “Smith” is entered in the search field, only employees with the name Smith may be displayed. In some instances, only one contact may match an identification provided in a search field. In other embodiments, the contacts that match the identification in the search field may be displayed at the top of the contact list, while other contacts may be displayed below. Alternatively, the contacts matching the search may be called out in any other manner, such as the presence of a visual indicator, such as highlighting, a font color, holding, an additional icon or symbol, larger font, outlining, and any other visual indicator that may cause a contact to stand out.

A category field 528b may enable a user to filter through contacts based on a contact category. One, two, or more category fields may be provided. For example, a category field may relate to a skill set. A category field may be for skills, and a feature, such as a drop-down menu (or any other type of user interactive interface) may be provided that allows a user to select from available skills. For example, for the employees of a restaurant, the available skills may be bartender, host, server, and so forth. Some employees may have one or more skill.

Selecting a contact category may cause the contact list to display only the contacts that match the contact category. For example, if the contact category is a skill, the contact list may only display employees with the selected skill. In another example, if the contact category is a location or location range, the contact list may only display employees that fall within the selected employee range. Other examples of contact categories may include a branch, department, group, seniority, employee pay scale, type of employee, etc. Any contact category may be provided which may enable a user to filter the contact list by selected categories.

In some embodiments, a plurality of contact category fields may be provided. For example, one field may be related to skills, and another field may be related to location. In some embodiments, the contact list may display contacts that fulfill both categories. In other embodiments, the contact list may display contacts that may fulfill at least one of the first category or the second category. In some embodiments, a user may be able to select whether the contact list displays contacts that fulfill both categories, or only at least one category. As any number of category fields may be provided, a user may be able to select any combination of relationships between the categories (e.g., whether all or some categories may be required while some categories may merely be preferable). For example, a mandatory category field may filter out contacts that do not meet the criteria of the category, while an optional category field may rank the contacts in an order based on the criteria of the optional category.

In some embodiments, one or more of the categories may include an option that may include all possible categories. For examples, a skills field may include an option that includes <All Skills>. In such a manner one or more categories may give the user the option to not be limited by that category.

As discussed previously, rather than only displaying a contact that fulfills a particular category, such contacts may be visually emphasized in some manner, such as appearing earlier in the list, or being called out by a visual indicator. In a situation where multiple categories may be provided, different visual indicators may indicate which category may apply to a particular contact. For example, a contact with a specified skill may be highlighted in yellow, while a contact within a desired location range may be highlighted in blue.

A location field 528c may be provided in a selected utility display. A user may be able to select a location. In a preferable embodiment, the user may be a manager and may select the location that the user is managing. In some embodiments, a location field may include a drop down menu (or any other user interactive interface) that may enable a user to select from a list of locations. For example, the locations provided at the location field may correspond to sites for an entity utilizing the manager toolkit. For example, if the manager toolkit recognizes it is being used for a pizza parlor chain, the available locations may be all of the sites of the various pizza parlors. Available locations may also be departments, groups, offices, branches, cost centers, or any other locations relevant to a user or entity accessing the manager toolkit.

A selected location may be reflected in the contact summary, and/or contact list region. For example, the selected location may be displayed in the contact summary. Furthermore, the selected location may cause the contacts to include distances of each contact from the selected location. In some embodiments, the contacts may be sorted according to a criteria. For example, the contacts may be displayed in order, based on which contact is closest to the selected location.

After a location has been selected, a user may change a location selection. In doing so, the location displayed in the contact summary may change. Also, the distances of each contact from the selected location may change correspondingly as well. In some instances, the order of the contacts may change, especially if contacts are displayed based on which contact is closest to the selected location. Some contacts may be closer to the newly selected location than to the previously selected location. In some embodiments, the distance of a contact from a location may be provided. The location of the contact may be defaulted as the contact's home address, or any other designated geo-location. In some embodiments, if the contact somehow notified the system that the contact is at a particular location, that location may become the contact's location. In some embodiments, a contact may have a GPS receiver which may notify the system of the contact's location, which may be used as the contact's location for purposes of the manager toolkit.

A location selection may also affect a category field. For example, in some embodiments, depending on the location selected, different categories may be available, or items listed for a particular category may be different. For example, for one location, only the skill category field may be available, while for another location, a skill category and an employee group category may be available. In another example, different types of skills may be available at different locations. For example, for one location, there may be bartenders, hosts, and servers, while in another location, there may be accountants and advertisers.

In some embodiments, a default location may be provided. In other embodiments, the default may be to not have a selected location. A default location may be based on the identity of the authorized user. For instance, if the recognized or authorized user is known to be at a location, the default location may be the same location.

In some embodiments, a company roster display may include a map access 512. In some embodiments, the map access and the location field may be adjacent to one another. For example, selecting the map access icon may result in opening another window or tab with a map. Alternatively, selecting the map access icon may cause a map to overlay the company roster page.

In some embodiments, selecting the map access 530 may cause the manager toolkit to plot the map. In other embodiments, the manager toolkit may interact with other applications, tools, or gadgets to plot the map. In some embodiments, the other application, tool, or gadget may be related to the manager toolkit. For example, if the manager toolkit is a Google gadget, the manager toolkit may utilize Google maps to plot the map. Or the manager toolkit may utilize any other type of pre-existing mapping application.

The map may plot the selected location and surrounding areas. A map may also plot the location of contacts with the contact list after it has been filtered to meet one or more criteria. For example, if four contacts have the requisite skill set, the map may plot the location of each of the four contacts. The selected location in relation to the four contacts may also be plotted. In some embodiments, only a maximum number of contacts may be plotted. For example, if the contact list includes ten contacts, it may be determined that only the top five contacts are plotted. The top five contacts may be based on proximity, skills, or any other criteria that may rank the contacts.

3. Roster Interface

FIG. 5B shows an example of a company roster page. As discussed previously, an entity logo 532 may be provided, which may overlay the company roster page and any other pages of the manager toolkit. In some embodiments, the logo may appear identical in every toolkit page. In other embodiments, the logo may be smaller or reduced for various pages. For example, the cover page may have a full-sized logo, while subsequent pages may have smaller logos.

The company roster page may also include a region that displays the utility title 534. For example, for the company roster page, the utility title may be ‘Roster View’. In some embodiments, the utility title may share a region with the identity/login region. In some embodiments, various parts of the company roster page may be accessed. In some instances, this may cause the utility title to change (e.g., ‘Skill Seek’ may show a contact card based with alternate mapping view, ‘Skill Map’ may show a map view). In some other instances, the utility title may remain the same as that for the company roster page when the user selects an action that falls under the company roster page.

The company roster page may also include various navigational tools 536 or interfaces to access parts of the page. For example, if the contact list region includes more contacts than fit within the company roster display, a scrollbar may be provided that may enable a user to scroll down the contact list.

As discussed previously, window controls 538 may be provided. For example, the company roster page may only include a window control to fold the page. Folding the page may return the user to the cover page. Thus, in some instances, closing the company roster page may be the same as sending the user back to the cover page, or to a previous page.

FIG. 5C shows an example of a workforce roster page. The workforce roster page may include one or more category fields 550a, 550b, such as a location field and a skill set field. The individuals matching the criteria laid out in the category fields may be listed. The listing of individuals 552 may allow a user to access additional information about the individual. In some embodiments, the total number of individuals 554 found matching the criteria may be displayed. A workforce roster interface may also provide access to other utilities 556a, 556b of the toolkit (e.g., by providing links), such as a resource map or a week view.

4. Contact Card

In some embodiments, the user may select a contact from the contact list. For example, a user may click on a contact name, which may cause a contact card to be displayed. The contact card may overlay the company roster view, or alternatively may be opened in another window or tab, or adjacent to the roster. The contact card view is discussed in further detail below. In some embodiments, the contact card view may include an option to fold the contact card. Selecting the option to fold the contact may close the card and return the user to the previous view. In some embodiments, folding the contact card may return the user to the company roster view. In some embodiments, the user may select an option to close the contact card view, i.e., when the contact card is displayed in another window.

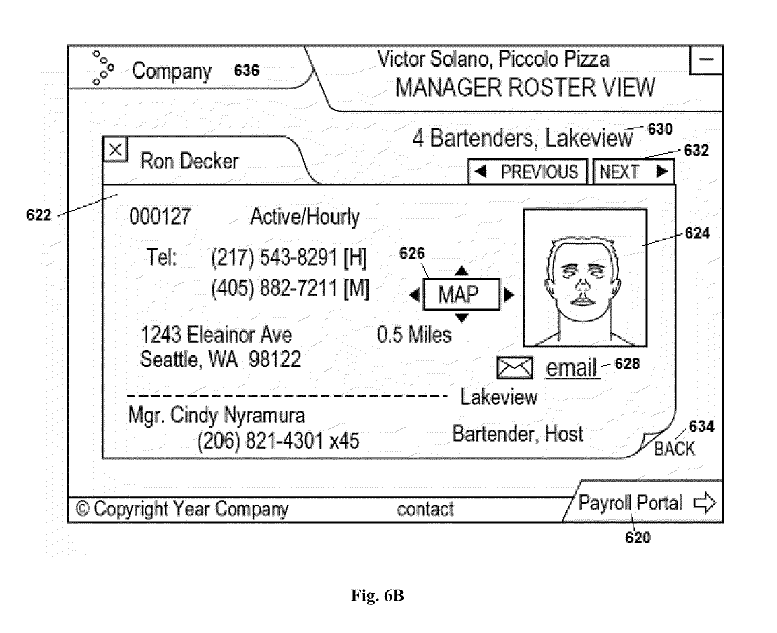

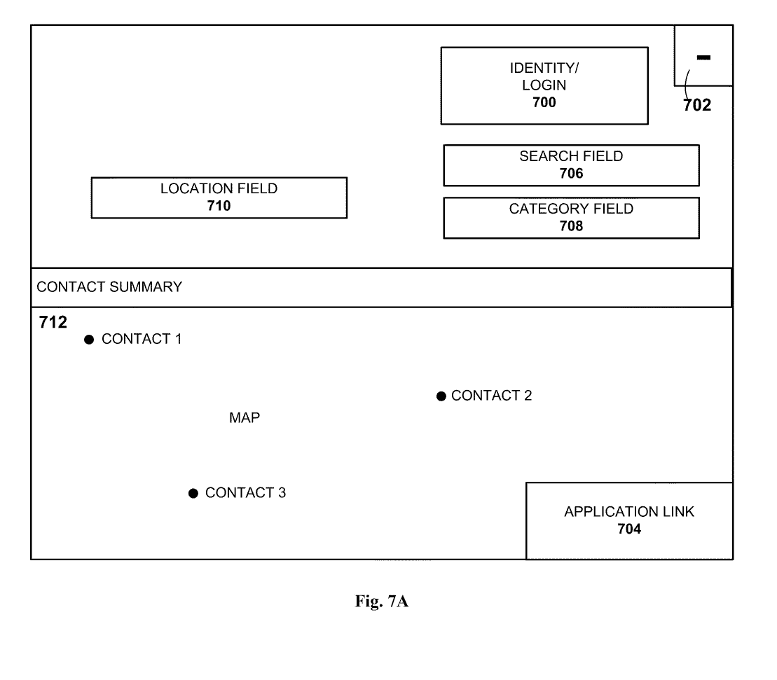

FIG. 6A shows an example of a contact card format. As discussed previously, features such as an identity/login region 600, window control 602, and/or application link 604, 620 may be displayed. These features may be displayed in any manner, including but not limited to the same manner in which they were displayed in any other page, such as the toolkit cover page or company roster page.

The contact card view may also display a contact detail region 606, 622. The contact detail region may display a contact name with additional information about the contact. The contact detail region may include more information or detail than the contact displayed in the contact list region of the company roster view. For example, the contact detail region may include information, such as the contact's identification number, the contact's title, the contact's employment status, the type of salaried employee that the contact is, the contact's telephone numbers, the contact's address or location, the contact's email, an image of the contact 624 (e.g., a photo on records), access to a map 626, the distance of the contact from the selected location, a list of the contact's skills (which may or may not be correlated to pay rates), the contact's base location, the contact's department (branch, location, group, office, or center), or the contact's manager or superior with the manager or superior's contact information.

The information provided in the contact detail region may also provide the user with access to more detail or to other views. For example, selecting the map access may provide a view of a map with location information about the selected contact. Or selecting the contact's email 628 may provide linked access that may open a window to email the contact. In another example, selecting the contact's manager name may open a window to allow the user to send an email to the manager, or may provide the user with greater access to the contact's manager. In some embodiments, it may open a chat window with the contact's manager, if the manager is also utilizing the manager toolkit.

The contact card view may carry over selected filters or echo the filter selection from the company roster view.

For example, the contact card view may also display a contact summary 608, 630. In some embodiments, the contact summary for the contact card view may display the same content as the contact summary for the company roster view. For example, as shown in FIG. 6B, it may show the total number of contacts that have a specified skill and a selected location. For examples, 4 bartenders may be by the Lakeview location. In some embodiments, the contact summary may also display information, such as however many bartenders there are in all locations.

A contact card view may also include a region for contact navigation 610, 632. For example, the contact navigation may enable a user to navigate from the contact card view for one contact to the contact card view for another contact. For example, the user may select an option to view a ‘previous’ contact or a ‘next’ contact. Any user interface may be provided, including but not limited to, buttons, a scroll bar, icons, thumbnails, or a drop down menu. The contact card view may have carried over selected filters, so that when the user navigates between contact cards, the contact cards available reflect the contacts that were displayed in the contact list region of the company roster view that were filtered to meet the selected criteria.

A contact card view may also include an option that returns a user to the previous utility 612, 634. The user may be returned to the company roster view.

FIG. 6B shows an example of a contact card view. The contact card view may have any design or configuration. In some instances, the contact region may have a format, like a digital online swipe-card ID. For example, the contact region may be a visually distinct region with the contact information.

As with other views, the contact card view may include a logo and utility title 636. The utility title may or may not share a region with the identity/login. The utility title may reflect that it is a contact card view (e.g., ‘Skill Seek’) or may reflect the prior view that it falls under (e.g., ‘Roster View’).

5. Projections

In some implementations, the system can suggest, compute, and/or advise on requests based on projections of current and past data, and current or past periodic accruals or deductions. The manager toolkit may access information, which may be stored in memory or on a database, and may utilize such information in the toolkit functions. The memory or database containing the information accessed by the manager toolkit may also be accessed by other applications, such as a payroll software application.

In one example, a vacation balance alert may be generated before an employee begins losing accrued time-off due to accrual limits, or advisories may be generated when an employee requests vacation, or a manager enters an employee's request for vacation. In another example, an employee may ask the system “How soon can I take a week off?” The system may be able to calculate based on current accrual, employee anniversary, and accrual tiers, and produce a date and a ready-to-use vacation request form. In another example, an employee may wish to maximize the employee's 401K contributions for the year, and ask the system how the employee needs to reset the employee's payroll deduction to achieve the maximum 401K contributions. The system may take into account the present month, e.g., June (6 months into the deduction year), and may know what the employee's earnings and deduction pattern is.

The manager toolkit may also take previous information and setting into account when providing contact list information or other information to a manager. For example, if a manager searches for an employee that may be able to take over a shift, the toolkit may be able to take into account information such as whether the employee has a lot of overtime hours, is on vacation, is located close to the site, and so forth.

6. Joint Decision-Making

In some embodiments, multiple users may be able to access a manager toolkit simultaneously. For example, two users (such as two managers) in different locations may be reviewing live on both users' manager toolkits an employee record, or any other information. When accessing the same form or data, a data modification made by one user may be visible to the other user simultaneously accessing the form or data. In some embodiments, the multiple users may be on the same type of device (such as computers), or may be on different types of devices (e.g., one user can be at a computer, while another user can be on a phone or other roaming device).

In some cases, the multiple users may be viewing the same record while talking on the phone, or any other audio communication device. This may occur during a mini-meeting scenario. The multiple users may be seeing the same screen, and each user may have role permissions to reveal and modify portions of the data record. In one implementation, this may be useful when the multiple users are co-editing a form. For example, two managers may be discussing an employee's performance and bonus level, and may be editing an employee performance review online at the same time.

In another example, two or more managers may be required to co-authorize a transaction. If both are accessing the manager toolkit, they may be able to co-authorize a transaction simultaneously and visibly in tandem. This may also be expanded to multi-authorizations, e.g., when any of three of seven company officers can approve a certain transaction, such as a transfer, termination, human resources transaction, or payroll approval. In such a situation, the minimum number of managers required to approve the transaction may access the toolkit to authorize the transaction simultaneously.

D. Map

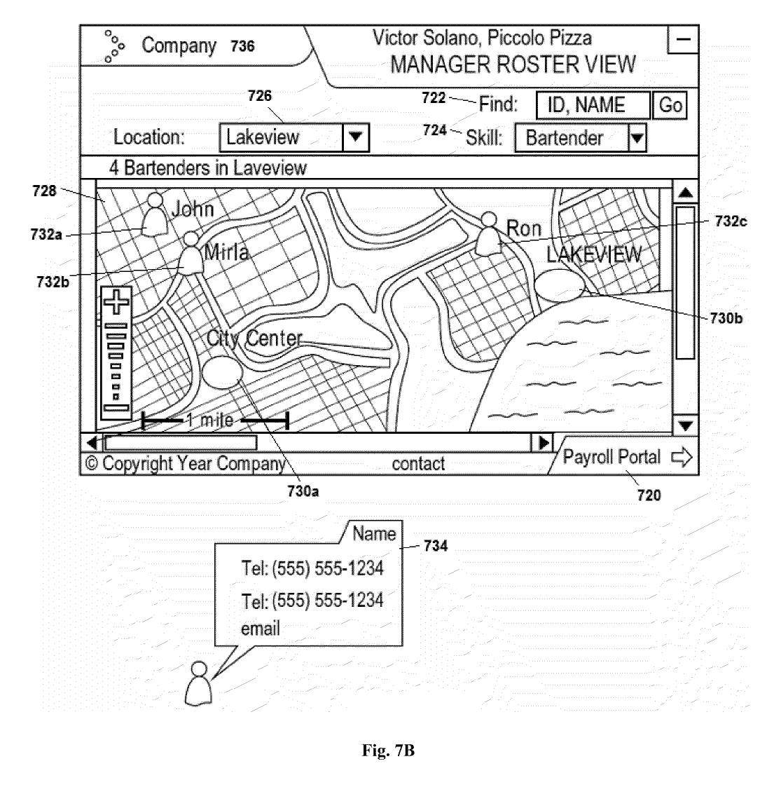

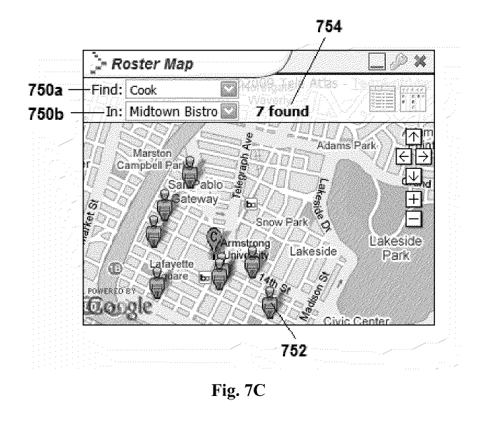

FIG. 7A shows an example of a resource map view format in accordance with one aspect of the invention. A manager toolkit may provide a user with access to one or more types of maps from various pages. For example, a toolkit cover page may include a utility for a Resource Map. Selecting the Resource Map utility may provide the user with access to a resource map view.

As discussed previously, features such as an identity/login region 700, window control 702, and/or application link may be displayed 704, 720. These features may be displayed in any manner, including but not limited to the same manner in which they were displayed in any other page, such as the toolkit cover page, company roster page, or contact card page.

The resource map page may include a search field 706, 722. In some embodiments, the search field may be similar or the same as the search field for the company roster page. Any of the implementations discussed previously may apply to the search field of the company roster page may also apply to the search field of the resource map page. The search field of the resource map page may also not be similar to the search field of the company roster page.

The resource map page may also include one or more category field 708, 724. In some embodiments, a category field may be similar or the same as a category field for the company roster page. Any of the implementations discussed previously may apply to a category field of the company roster page may also apply to a category field of the resource map page. The one or more category fields of the resource map page may also not be similar to the one or more category fields of the company roster page.

A location field 710, 726 may also be provided by the resource map page. In some embodiments, a location field may be similar or the same as a location field for the company roster page. Any of the implementations discussed previously may apply to a location field of the company roster page may also apply to a location field of the resource map page. The location field of the resource map page may also not be similar to the location field of the company roster page.

The resource map page may also include a map region 712, 728. As discussed previously, the map region may be provided by a map application within the manager toolkit, or within a shared application, such as another map program, such as Google maps, Yahoo maps, Mapquest, etc., or any other map application that may be accessed by the manager toolkit. In a preferable embodiment, the map may appear within the manager toolkit user interface in the resource map page. The resource map may overlay the previous page. Alternatively, the resource map may appear in a separate window or tab.

A user may enter and/or select a value for a search field, a category field, and/or location field. The map view may reflect any values for any fields that may be provided. For example, the resource map may display a selected location. If a user selects a branch location of the company, that branch location and surroundings may be displayed in the resource map. Similarly, if the user searches for a contact, the contact may appear on the map. For example, as shown in FIG. 7A, multiple contacts may be provided in different places along the resource map. The branch location may also be visible in the map. Similarly, if the user selects a category value, such as bartenders for a skill set, the resource map may display all of the bartenders that are located near the selected location. In some embodiments, when accessing a map resource view, the user may modify the value of a field. Modifying the value of the field may modify the map.

The resource map may have a default scope, which the user may or may not zoom in and out from. In some embodiments, the default map scope may depend on the values selected. For example, if the contacts that have a selected skill are located somewhat far from a selected location, the map may be more zoomed out initially than if only a location were selected, or if the contacts were located more closely to the selected location.

In some instances, if more than one location that may be selected from a location field falls within the scope of the map, all locations that fall within the scope of the map may be displayed. For example, if two branches are in 730a, 730b close proximity to one another, both may appear on the map. In one example, as shown in FIG. 6B, both the City Center and Lakeview locations may fall within the scope of the map and be displayed.

The resource map view may be accessed from other pages or regions of the manager toolkit as well. For example, a company roster page may include a map access. In another example, a contact card may include a map access as well.

In some embodiments, the resource map view may depend on how the resource map was accessed. For example, if the resource map is accessed from the cover page, the fields may or more not have a default value. For example a default location may be provided (e.g., the location of a recognized user) so that a general map area may be provided. However, no categories or skill sets may be selected, in which case, no contacts may be displayed on the map.

In another example, the resource map may be accessed from a company roster. For example, the map may be accessed after a category value has been selected or a user name entered in the search field, or a contact list otherwise populated. The resource map may then also display contacts 732a, 732b, 732c initially. The values selected from the company roster view and/or the contacts within the contact list of the company roster view may persist to the resource map page.

In another example, the map may be accessed from a contact card, which may cause the contact location to be displayed initially.

The various fields provided by the map resource view may function as focus filters that may enable a user to narrow contacts to be displayed. Some focus filters may include locations, skills, or user searches, or any other types of categories relating to contacts, as discussed previously. A user may modify any of these fields while in the resource map view. The map region may then be modified to reflect the user selections of the fields.

In some embodiments, if the user returns to a company roster view after modifying a field value in a resource map view, the company roster view may reflect the change made. Thus, values selected from the resource map view may persist to the company roster page. In other embodiments, returning to a company roster view may cause the field values to default to what they had previously been in the company roster view, without including any modifications by the user while in the resource map view. Thus, any filters or fields used may carry over between any of the various pages of the toolkit. Any map features known in the art or later developed may be utilized. See e.g., U.S. Patent Publication No. 2007/0162537 and U.S. Patent Publication No. 2007/0067175, which are hereby incorporated by reference in their entirety.

In some implementations, when accessing a map resource view from a company roster view or vice versa, a portion of the user interface may remain the same while a portion of the user interface may change. For example, an application link, window control, login/identity region, fields, and contact summary may remain the same while a contact list region and map region may change. For example, the contact list region of the company roster view and the map region of the resource map view may both be at a lower portion of the user interface. These regions may be displayed on any portion of the user interface but may cover the same area. Thus, when a user accesses a resource map view from a company roster view, the contact list region may be overlaid with the map region. Similarly, selecting a location on a map may show a mini-card with information about the location. In some embodiments, such information about a location may include information about employees that work at that location, or any other employee management or payroll data pertinent to that location.

The fields, which may function as focus filters, may persist above the map region or the contact list region for a single-screen ‘Locate Skilled Person’ experience. The focus filters may persist as the map region changes based on user interaction, or the contact list region changes based on user interaction, or the map region and the contact list region are interchanged.

When a user accesses a company roster view from a resource map view, the map region may be overlaid with a contact list region. In some implementations, when a user navigates from one page of the manager toolkit to another page, a region of the page may be overlaid by another region from the other page.

Any map interface tool, as known in the art may be provided. For example, scroll bars or buttons may be provided that may enable a user to pan a map. Similarly, tools may be provided that may enable a user to zoom in and out of the map. The map interface tools may reflect the application used to generate the map (e.g., using Google maps may enable a user to engage in the features commonly available to users using Google maps).

In some embodiments, a user may be able to select, click or otherwise access a contact or selected location to view further information about the contact or selected location. For example, clicking on a contact on a map may show a mini-card 734 with information about the contact, such as contact info or geo-data (e.g., distance to the contact from the selected location). The mini-card may overlay a portion of the map region. Alternatively, the mini-card may appear in another window or tab. A mini-card could overlay the entire map region. Selecting a contact may open a contact card view. Alternatively, a mini-card may include a link to a contact card view, which may overlay the resource map view.

A user may also select an option to close the mini-card. Closing a mini-card which may overlay a portion of another view may remove the mini-card from the view. Closing a mini-card which may appear in a separate window or tab may close the separate window or tab.

In some embodiments, selecting a contact may also display geo-data, such as the distance of the contact from a selected location.

FIG. 7B shows an example of a resource map view. As shown in the Figure, in some embodiments, contacts 732a, 732b, 732c and/or locations 730a, 730b may be displayed by any form of visual indicator. For example, a contact and/or location may be displayed by an icon. Different icons may be provided for contacts and locations, or other items, such as delivery trucks. Different icons/markers may also be used for employees with different skills or availability; alternatively, the same icons may be used for all contacts. Contacts and/or locations may also be displayed with a label (e.g., contact name, location name).

In some embodiments, the location for various items, such as a branch office or home address of a contact, may be fixed. Sometimes, the locations for the items may change, such as the location of a delivery truck or the location of a contact. Sometimes changes in location for particular items may be tracked by a tracking device, such as GPS, or may be tracked when the item accesses a checkpoint or conveys information to the manager toolkit on its location.

As with other views, the resource map view may include a logo and utility title 736. The utility title may or may not share a region with the identity/login. The utility title may reflect that it is a resource map view (e.g., ‘Resource Map’) or may reflect the prior view that it falls under (e.g., ‘Roster View’).

A map resource page may be closed or folded. In some embodiments, closing a map resource page may return the user to the previous page. In some embodiments, the map resource page may have been accessed from a cover page, company roster page, or a contact card page, and closing the map resource page may direct the user back to the cover page, company roster page, or contact card page respectively. In other embodiments, a default return page may be provided. For example, closing the map resource page may always direct the user back to a cover page, or any other page. In some embodiments, navigational tools may be provided on the map resource page that may direct the user to the next page. For example, selecting a ‘list’ option from the map resource page may swap the view to a company roster page with a contact list.

FIG. 7C shows an example of a map view. Like a workforce roster, the map view may include one or more category fields 750a, 750b, such as a location field and a skill set field. The location of the individuals matching the criteria laid out in the category fields may be displayed on a map. The icons or markers for the individuals 752 may allow a user to access additional information about the individual. In some embodiments, additional icons or markers may be provided for other individuals or points of interest within the area covered by the map (e.g., the location of a particular facility, train stations, etc.). In some embodiments, the total number 754 of individuals found matching the criteria may be displayed. A map view interface may also provide access to other utilities of the toolkit (e.g., by providing links), such as a workforce roster or a week view.

E. Timescape

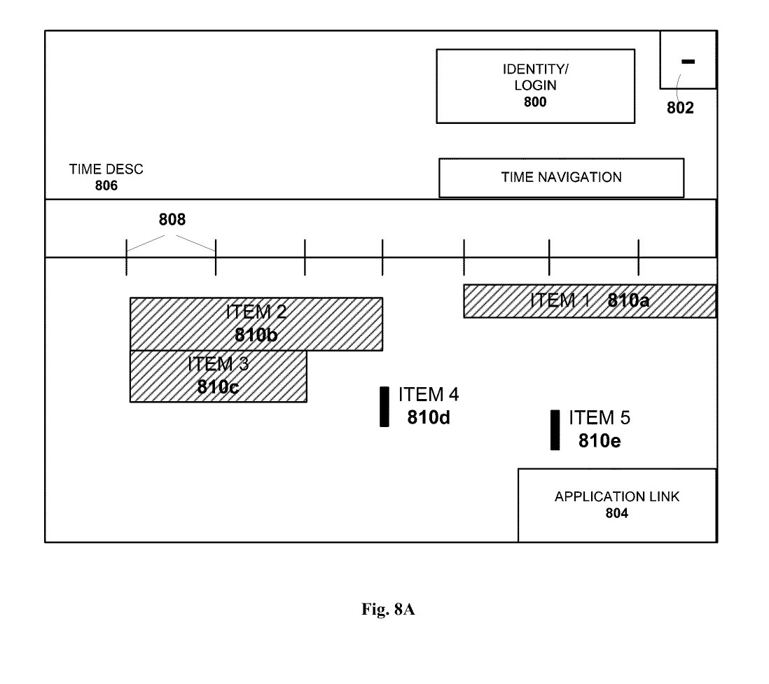

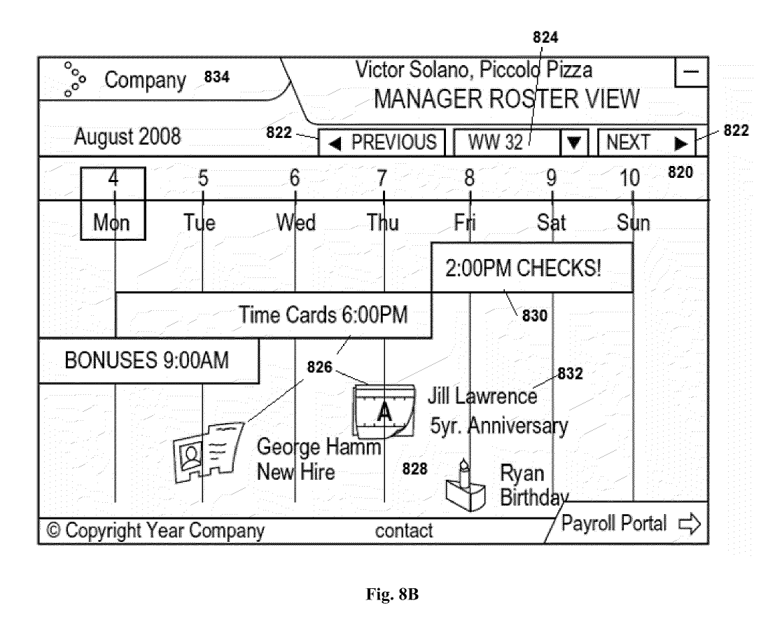

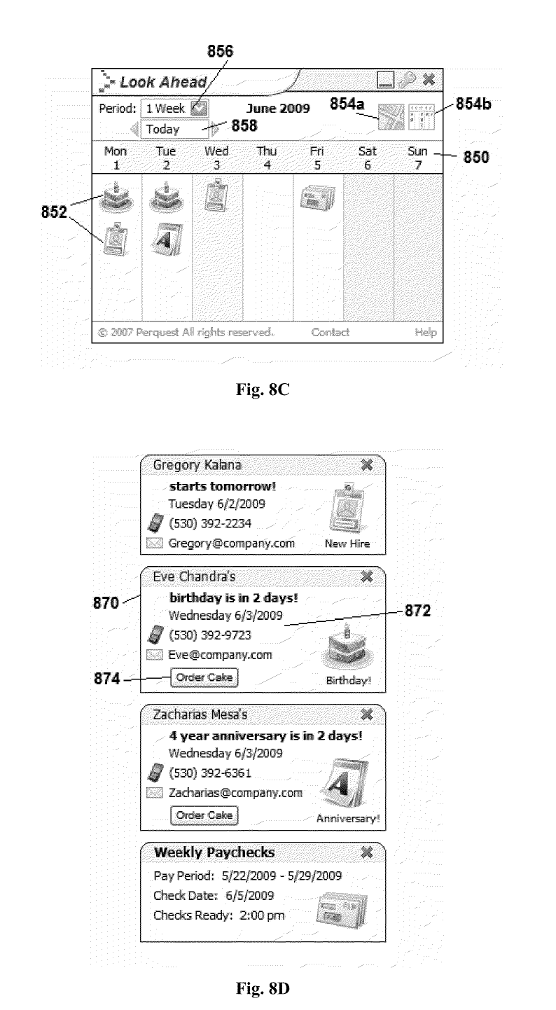

FIG. 8A shows an example of a timescape layout for the toolkit. A manager toolkit may provide a user with access to a timescape page. For example, a toolkit cover page may include a utility for a Manager Week. In some embodiments, a toolkit cover page may provide access to only one type of timescape utility, while in other applications, separate utilities may be provided for various timescape utilities. For example a ‘Week Peek’ timescape and a ‘Month Peek’ timescape may be provided separately. In some embodiments, multiple timescape applications may have similar user interfaces with different defaults, while in other embodiments, the user interfaces may vary. In some embodiments, the timescape utility may have another name, such as “WeekPeek”, “Plan-a-Week”, “ThisWeek”, or “ManagerWeek”. Selecting the Manager Week utility may provide the user with access to a timescape view. Each timescape view may focus on a time window and aggregates payroll and human resources (HR) events within an organizational focus.

As discussed previously, features such as an identity/login region 800, window control 802, and/or application link 804 may be displayed. These features may be displayed in any manner, including but not limited to the same manner in which they were displayed in any other page, such as the toolkit cover page, company roster page, contact card page, or resource map page.

The timescape view may present a time description region 806 that may display a time category, time period, or other time-related unit. The time description region may relate to time-related data displayed in a calendar region.

A time category may include any data sequence, which may include a given period of time or may relate to data status. Both periods of time and data statuses may have a sequence. An earlier time category, where the time category may relate to a period of time, may include a time period that is earlier in time. An earlier time category, where the time category may relate to data status, may include data status that is farther along in a sequence and vice versa, since data from an earlier time may be further along in a status sequence. So for example, a time category for submitted payroll data may be considered earlier than a time category for open payroll data even if submitted payroll data is further along in a sequence because submitted payroll data relates to data from an earlier time. Similarly, submitted payroll data may also be considered to precede or be prior to open payroll data. Any discussion herein for a time period may also apply to any time category, and vice versa. So any discussion herein of time period comparison may also apply to comparison with any time category, which may include a period of time or data status.

A given period of time may relate to any length of time, whether the period of time relate to calendar units of time, smaller measurement units of time, or event-driven units of time. In a preferable embodiment of the invention, a given period of time may be a pay period. A pay period in the payroll processing art may be the intervals that employees are paid at, and may usually be chosen by an employer. Commonly, employees may be paid weekly, biweekly, semimonthly, or monthly, although other pay periods are possible. The period of time may be adaptable for any pay period desired by an employer. For example, a period of time could change from a month to a week if an employer were to change monthly pay periods to weekly pay periods.

In an alternate embodiment, the given period of time may be based on calendar units such as years, months, weeks, days. In another embodiment, the periods of times may be for smaller measurement units of time, such as hours, minutes, seconds, or portions thereof. In other embodiments, periods of time may vary in length and may be an event-driven unit of time, or may occur when an administrator of a system may decide to change the time period, and so forth.

Data status may relate to the status of data, which may or may not be related to the passage of time. Data status may have a sequence or progression so that data starts out with a particular status, then progresses to another status, and so forth. For example, payroll data may start a sequence as unopened payroll data, then become opened payroll data, then become submitted payroll data. Data status may be related to time if status sequence may be related to time. For instance, payroll data may start earliest in time as unopened payroll data, and after some time may become opened payroll data, and after some additional time may become submitted payroll data. As discussed previously, an earliest time category, where the time category may relate to data status, may include data status that is farthest along in a sequence and vice versa, since data from an earlier time may be further along in a status sequence. For example, an earlier time category may include a pay period that was closed earlier or that occurred earlier in time.

1. Timescape Display

In a preferable embodiment of the invention, the time description region 806 may be a time period, such as a month. For example, the timescape view may indicate that the view is within the month of August 2008 while additional time indicators 808 (such as hatch marks, bars, dots, icons, or numbers) may be used to delineate smaller units of time. In that example, the hatch marks may show the days of the upcoming or present week. FIG. 8B shows an example where the week in August is shown, starting on Monday the 4th and ending on Sunday the 10th, with time indicators 820 for each of the days.

Time indicators may be arranged in any manner. Preferably, they may be arranged in a linear matter. For instance time indicators may be displayed in a horizontal linear manner, where each indicator may demarcate a unit of time (e.g., a minute, an hour, a day, a week, a month, a year, etc.). Alternatively, time indicators may be displayed in a vertical linear manner.

The scope of the time indicators displayed in the timescape may have a default. For example, the default may be to display a week, such as an upcoming or present week. The default could be to display the week starting on a particular day of the week (e.g., Monday) or starting on the present day, whatever day of the week that may be. In other examples, the scope of the time indicators may default to a time period such as a day, two weeks, a month, a quarter, or a year; or a time period that may be tied into an event, such as a payroll period. In some embodiments, fields or filters may be provided that may set the time window for the time indicators with various standards. For example, a user may select an option to display 1 week, 2 weeks, 1 month, a pay period, or any other selected time period from the field.

FIG. 8C shows an example of a toolkit timescape with a week view look ahead. For example, each of the days of the week 850 may be displayed in a linear fashion. Event icons 852 (or any other visual indicator) may be visually mapped to the corresponding day of the week. For example, if the days of the week are displayed horizontally, the event icons may be mapped vertically to the corresponding day. The event icons may be different for different types of events (e.g., a different icon for a birthday, new employee start date, anniversary date, or paycheck date). A timescape interface may also provide access to other utilities 854a, 854b of the toolkit (e.g., by providing links), such as a resource map or a workforce roster.

The toolkit timescape may include an interface 856 for selecting a time period to be displayed. For example, a user may select a week to display a week view. Alternatively, a user may select any other time period (e.g., day, month, year) to display different periods of time. A user may also select a focus time 858. For example, in a week view, a user may select a particular day (e.g., ‘Today’, ‘Yesterday’, ‘Tomorrow’). The selected focus time may be highlighted or otherwise visually accentuated on the timescape interface. For example, if ‘Today’ is selected, and ‘Today’ is the Wednesday of the week, then Wednesday may be highlighted.

Any display relating to time may be provided for a manager toolkit. Any time-related features as are known in the art may be utilized. See e.g., U.S. Patent Publication No. 2007/0150327, which is hereby incorporated by reference in its entirety.

2. Timescape Controls

In some embodiments, zoom controls may be provided so that a user may pan forward or backwards 822 along the time indicated, or zoom in or out of the time indicated. In some embodiments, such zoom controls may be provided within a time navigation region. In other embodiments, such zoom controls may be provided anywhere along the timescape interface.

A user may pan forward or backwards along the time indicated. For instance, for whatever time period is being displayed, the user may be able to access a prior or subsequent time period. For example, if a week is being displayed, the user may be able to view a previous week or a next week. In some embodiments, the time may automatically be displayed in week increments that may start on the same day (e.g., Monday). A user may select a ‘Previous’ or ‘Next’ button to access previous or subsequent weeks. Alternatively, if a month is being displayed, selecting ‘Previous’ or ‘Next’ may access previous or subsequent months.

In some embodiments, a user may be able to move forward or backwards along the displayed time along smaller increments than the displayed time period. For example, if a week is being displayed (e.g., starting on a Monday), a user may be able to move the timescape back a day, so the user is viewing a week starting on the previous day (e.g., starting on Sunday). In some embodiments, clicking and dragging may enable a user to move a timescape forward and backwards in a fluid or substantially fluid, or smaller incremental manner. Thus a user may be able to pan forwards and backwards with a user interactive implement, such as a mouse, keyboard, trackball, or any other type of implement, or using hand or finger gestures with a touch screen. Any other user interactive interface may enable a user to move forward and backward in time.

Time navigation controls may be provided that may enable a user to skip forward or backward in time. For example, a drop down menu 824 may be provided that may display the present time period displayed. In one implementation, if the time period being displayed is a week, the drop down menu may provide a list of available weeks for display. A user may select any of the weeks available from the list and skip to that week. Any other user interactive interface may be used to enable a user to select a time period.

A user may also zoom in and out of the time indicated. For example, the time period being displayed may be a week. A user may be able to zoom out to view a larger time period, such as two weeks, or a month. A user may be able to zoom in to view a smaller time period, such as a day or hour. In some embodiments, zooming in or zooming out may cause the time indicators to adjust accordingly. When zooming out to view a larger time period, the time indicators may indicate a larger period of time. For example, if the time indicators in a week view were for a day, the time indicators in a month view may be for a week, or several days. When zooming in to view a smaller time period, the time indicators may indicate a smaller period of time. For example, if the indicators in a week view were for a day, the time indicators in a day view may be for an hour. In other embodiments, zooming in or zooming out may not cause the time indicators to adjust accordingly.

In some embodiments, presets may be provided for varying zoom degrees. For examples, presets may be provided for a week view, a bi-weekly view, or a month view. The presets may appear in any user interactive manner, such as a drop down menu, a button or series of buttons, icons, or a scroll bar. In one example, a period focus tool may be provided. A user viewing a time period may be able to select a smaller time period indicated by one or more time indicator. For example, a week view may be displayed, and a user moving a cursor between two time indicators representing days may highlight the space between the two time indicators. Selecting the highlighted space may cause the calendar region to zoom into a view of the day indicated by the space between the two time indicators. In some embodiments, zoom controls may be provided that may zoom out or in from an existing view by in an incremental or fluid manner.

3. Timescape Data

In a preferable embodiment of the invention, the data displayed in the calendar region may include payroll data. Such payroll data may include data pertaining to employees, associated partners, or other pertinent parties. Payroll data may related to information such as payroll liability and payroll progress, such as worksheets for various employee groups, various payroll items and amounts, information on already submitted payroll, whether processing is complete, whether direct deposits or checks were sent, and so forth. For instance, a calendar region may display posted payroll events 826 such as timecards due, bonus request due, new hires, terminations (plan ahead), going on/returning from leave, birthdays, employment anniversaries, and other payroll or employee related data. The data may also include any other human capital management data or any other type of data.

The data displayed may relate to all directed managed employees of an authorized user. For example, if a user has been recognized or authenticated in order to reach the timescape page of the manager toolkit, the timescape view may only display information that is relevant to the user. For example, if the user is a manager at a particular location, only information relating to that particular location may be displayed. In some embodiments, a location selection from another page, such as a company roster page or resource map page may carry over the timescape view. In some embodiments, a default location may be provided based on a recognized user or a recognized device or cookie. In alternate embodiments, no default location may be provided and the timescape view may display no information until a location is selected, or may display all information relating to a company.

A location field may be provided in the timescape page. A user may select a location to affect the information displayed in the calendar region. If a user changes a location selection, the calendar region may change correspondingly to reflect information about events occurring during the displayed time period for the newly selected location.

Similarly, additional fields or filters may be provided. Such fields or filters may define criteria that may narrow the information displayed in the calendar region. For example, a filter may narrow the view to only items relating to payroll. Another filter may narrow the view only to items relating to specific upcoming events. In some embodiments, certain events may have different levels of importance and another filter may be to display events with only a high level of importance. Filters may be provided to narrow particular categories of information displayed.

In some instances, only employees with events may be visible in the calendar region. For example, specific information about an employee may be visible if an event relating to the employee will occur during the time period displayed (e.g., birthday, anniversary, new hire).

In some embodiments, items or data displayed may also relate to company wide events. For example in certain wider setups, certain events may be visible company wide, which may allow a useful ‘glimpse’ across corporate hierarchy in support of manager functions. Thus, the display need not be limited to location-based items, or items that relate only to the user.

The calendar region may display one or more item, which may relate to payroll data, employee data, HR data, human capital management data, or any other type of data. For example, some of items may relate to payroll and/or HR events. Some events may include paycheck dates, birthdays, hiring anniversaries, new hires, and any other event.

The items may be visually mapped to a time indicator. A first object may be visually mapped to a second object if they are somehow visually aligned or correspond, are visually associated, or show a relationship between the first and second object. For instance, one example of visual mapping between a plurality of objects may occur when the plurality of objects are in the same row or column (e.g., if an x-y coordinate system, objects may be visually mapped if they share the same x-coordinate while the y-coordinate may vary, or if they share the same y-coordinate while the x-coordinate may vary). For example, if time indicators are displayed in a horizontally linear manner, the items may be visually mapped to the time indicators in a vertical fashion. For example, an in item relating a particular time may fall vertically beneath the relevant time indicator. If the time indicators are displayed in a vertically linear manner, the items relating to a particular time may fall horizontally beside the relevant time indicator.

In some embodiments, an item may be ongoing or discrete. As shown in FIG. 8A, examples of an ongoing items may include Item 1, Item 2, and Item 3 810a, 810b, 810c. Examples of discrete items may include Item 4 and Item 5 810d, 810e. The beginning of ongoing Item 1 may correspond to the fifth time indicator, the end of ongoing Item 2 may correspond to the fourth time indicator, and the end of ongoing Item 3 may correspond to the third time indicator. Item 4 may correspond to the fourth time indicator, and Item 5 may correspond to the sixth time indicator.

In some embodiments, a discrete item 828, or the beginning and/or end of an ongoing item 830 need not fall directly below a time indicator. For example, as shown in FIG. 8B, check distribution may be indicated from 2:00 pm on a Thursday afternoon, and may be placed at the appropriate place between the Thursday and Friday time indicators accordingly. Similarly, time cards may have until 6:00 pm on a Thursday afternoon, and the ending of the time card item may be placed at the appropriate place between the Thursday and Friday time indicators accordingly. Bonuses may have until 9:00 am on Tuesday to be submitted, and the end of the bonus item may be placed between the Tuesday and Wednesday time indicators. In some embodiments, the beginning and/or ends of an ongoing item or a discrete item may be placed between two time indicators, but need not correspond directly to the time at which they occur. For example, an item that starts at 2:00 pm on one day, and another item that ends at 6:00 pm on the same day may be aligned, even though the times are not exactly the same. In other embodiments, such items may be proportionally displayed according to their time. In some instances, events occurring at different times need not be aligned.

In some instances, an ongoing item may be displayed using any form of visual indicator, such as a bar, a line, an arrow, a plurality of symbols or letters, icons, or any other shape or form. In some embodiments, the item may include a colored or shaded component. In some embodiments, the item color or shade may darken as the end or beginning of an item is approached.

Discrete items may be displayed by any form of visual indicator. In a preferable embodiment, the discrete item may be displayed by an icon. Some examples of icons may include a dot, bar, shape, symbol, etc. The icons may be same for one or more items, or may vary depending on the item. In some embodiments, icon sizes may be commensurate with the timescape interface. For example, an icon may appear smaller when a greater time period is being displayed. Similarly, when a smaller time period is being displayed, an icon may appear correspondingly larger.

Discrete items may be displayed aligned with a time indicator, or may be displayed between time indicators, depending on the item. In some embodiments, the discrete items may relate to a day, such as an employee's anniversary, or the hiring of a new employee, or an employee's birthday. Some discrete items may relate to an all-day event or an event that may occur anytime during the day. In such cases, the discrete items may be displayed directly aligned with a time indicator. In other embodiments, a discrete item may refer to a particular time in a day, and may be displayed in the appropriate position between the time indicators for the day and the subsequent day.

In some embodiments, zooming in may more accurately pinpoint the occurrence of a discrete item or the beginning and/or ending of an ongoing item.

In some embodiments, a translucent cursor region may be provided. In some instances, the translucent cursor may appear when there are wider time windows (e.g., 1 month, 3 months, 6 months, year, etc.). Items located underneath the cursor region may appear larger or with additional detail, color, or with labels. Users may move the cursor region horizontally (or in other embodiments vertically, or in any other direction). The cursor region may include a hairline indicator that precisely indicates the calendar date currently at the center of the cursor region. When the cursor region is over an item, additional detail may appear below a timescape (and aligned with the position of the cursor hairline). Such information may include the start and end dates of the timescape region under the cursor region, detail event or item information (one or more) currently under the vertical cursor hairline.

4. Event Card

FIG. 8B shows an example of a timescape for the toolkit. As shown in the Figure, in some embodiments, employee names 832 or other forms of visual indicators for a particular employee may be displayed on the calendar region, or any other part of the timescape page. A user may select the user name or icon, which may either bring up a contact card view, or a mini-card, as described previously. The contact card or mini-card may overlay the timescape page. In some embodiments, the contact card or mini-card may be closed, which may return the user to an unimpeded view of the timescape page.

Similarly, for any event or item, an item name, bar, or icon, or any other form of visual indicator may be provided. In some embodiments, a user may select the visual indicator for the item. In some embodiments, such selection or user interaction with the item indicator may highlight the item indicator. Selecting the item indicator may cause an event card or event mini-card to open. In some instances, an event card may take up the user interface of the toolkit screen and may overlay the timescape page. In other instances, an event card may be opened in a separate window or tab. An event mini-card may be similar to an event card except it need not overlay an entire screen, but may be a smaller portion of the screen, or if opened in a separate window or tab may be smaller.

An event card may include more details or information and possible links and actions related to the item. In some embodiments, the event card may provide the user with access to new windows or browser pages relating to the item. For example, a paycheck date may list employees receiving checks that day. This may be useful when personally distributing bonus or commission checks, and in company environments where checks are physically printed and handed out. In another example, for birthday or anniversary events, the event card may include actions to ordering gifts and scheduling celebrations. New hire event cards may include links to training and orientations. In some instances, mini-cards may be provided, which may include similar content as an event card, or may include a condensed or summarized version of the content of an event card.

FIG. 8D shows an example of an event detail display. In some embodiments, event cards 870 may be provided for individual events, or event details may be displayed for a plurality of events within a certain time period (e.g., the events on a particular day, within a particular week, or within any selected time period). As previously discussed, an event detail display may include additional details 872 about particular events, such as new hires, birthdays, anniversaries, paychecks, or other events. In some instances, an event display may include an action facilitator 874. The action facilitator may aid a user in taking an action related to the event. For example, if the event is a person's birthday or anniversary, a feature may be provided to help someone order cake. The action facilitator may direct the user to another interface where they can perform the action (e.g., a cake ordering website), or may provide the user with a reminder to perform the action (e.g., putting a reminder to order cake in the user's calendar). The event display may include an event icon which may correspond to an event icon on a timescape.

In some embodiments, event cards may include navigation controls. For example, an event card may include a user interactive interface, such as buttons, where a user may select ‘Previous’ or ‘Next’. In some embodiments, selecting ‘Previous’ may display an event card for an event that takes place prior to the event provided, and selecting ‘Next’ may display an event card for an event that takes place after the event provided.

In some embodiments, an alternate view may be provided, which may collect all of the timescape events and reorganize them in an agenda of events. The agenda of events may be another view of the events, such as a vertical scrolling list. The agenda of events may have any other format, such as a traditional monthly calendar view, a horizontal list, or a single timeline. In some embodiments, the agenda of events may only display events that fall within a time period that was displayed by the timescape view. In other embodiments, the agenda of events may have a wider time period, or a more narrow time period, or may only display a particular number of items.

As with other views, the timescape view may include a logo and utility title 834. The utility title may or may not share a region with the identity/login. The utility title may reflect that it is a resource map view (e.g., ‘Manager Week’).

A timescape page may be closed or folded. In some embodiments, closing a timescape page may return the user to the previous page. In some embodiments, the timescape page may have been accessed from a cover page, and closing the map resource page may direct the user back to the cover page. In some embodiments, navigational tools may be provided on the timescape page that may direct the user to another page. For example, selecting a ‘list’ option from the map resource page may swap the view to a company roster page with a contact list.

Any other implementations or examples that may be applied to the timescape page may be applied by U.S. patent application Ser. No. 12/053,498 filed Mar. 21, 2008, which is hereby incorporated by reference in its entirety.

Example of Implementation

An exemplary use of a manager toolkit may be provided below. Victor, a restaurant manager, may be a user of a manager toolkit. Victor may or may not be the owner of the restaurant, Piccolo Pizza, which may be a small business with 3 locations: Marina, Lakeside, and City Center. Victor may be using the manager toolkit to access pooled employee resources with possible daily reassignments to alternate shifts and locations. In the restaurant scenario, a ‘location’ may be synonymous with ‘group’, while other scenarios may have multiple groups in single location.

The situation may arise where Victor needs an additional waiter for that night, and wants to see who is available. Victor may access the company roster page of the manager toolkit. Victor may filter all of the employees in the roster for the ‘waiter’ skill and time window. A contact list may be visible with the available employees. In some embodiments, the contact list may include payroll data for the employees, including pay rates or overtime hours, as well as contact information for the employees.

Victor may click on an employee name to open an employee card with more detailed information. For example, clicking on a phone icon may initiate a phone call (e.g., in a phone embedded toolkit). Clicking on a message icon may launch a quick communication card to send email or phone text messages. In some instances, the communication card may contain template requests with standard fields for no-typing messages. For example, a standard message may be, “Can you do an extra shift?” with start and end times. Another example of a message may be, “Can you sub (substitute) and swap with <name>?” with start, end times.

When Victor is searching through the contact list, the scenario may come up where two employees are available, and Victor needs to determine who to choose. For example, suppose a search yields both Mary and Mario. Employee cards may include key payroll data such as current overtime and double time hours already worked by this employee. An employee card may also display up-to-date time clock data and visual hour meters. Such information may enable Victor to decide to call Mary first since working an extra shift tonight will not put her into mandatory overtime pay.

In some instances, Victor may determine whether to select Mario or Mary based on location. For example, if Victor needs a waiter immediately, he may see that Mario is closer to the parlor that needs the waiter, and contact him first.

Victor may also wonder where two of his delivery trucks are. GPS positioning may be integrated with a map view of the manager toolkit to enable quick real-time re-routing decisions.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A user interface for human capital management comprising:
a toolkit for accessing a human capital or payroll database to provide quick access to human capital or payroll data,
wherein the toolkit accesses a customized subset of the data stored in the human capital or payroll database for individualized purposes.

2. The user interface of claim 1, wherein the toolkit comprises a resource map.

3. The user interface of claim 2, wherein the resource map includes a display of search criteria and location markers on a graphical map for employees that meet the search criteria.

4. The user interface of claim 3, wherein the search criteria include at least one of the following: search field, category field, or location field.

5. The user interface of claim 1, wherein the toolkit comprises a time-related display of payroll events.

6. The user interface of claim 5, wherein the time-related display includes a linear display of time with one or more event icon displayed along the linear display of time at a location visually mapped to the time that an event represented by the event icon occurs.

7. The user interface of claim 6 wherein selecting the event icon provides a display with details relating to the event represented by the event icon.

8. The user interface of claim 1, wherein the toolkit comprises a workforce roster page with a list of employees.

9. The user interface of claim 8, wherein the workforce roster page includes a display of one or more contact field and the list of employees includes employees meeting conditions provided in the one or more contact field.

10. The user interface of claim 9 wherein the contact field includes at least one of the following: search field, category field, or location field.

11. The user interface of claim 1, wherein the data stored in the human capital or payroll database is also accessed by a full-sized software application.

12. The user interface of claim 10, wherein the full-sized software application is a human capital or payroll application which uses greater processing power than the toolkit when in use.

13. A human capital management system comprising:
a toolkit for providing access to human capital or payroll data, the toolkit including a resource map and a time-related display of human capital or payroll events, wherein the toolkit is stored in memory.

14. The human capital management system of claim 13, further comprising an additional software for providing access to human capital or payroll data, wherein the human capital or payroll data is shared with the additional software.

15. The human capital management system of claim 14, wherein the toolkit accesses a subset of the information stored in memory that may be accessed by the additional software.

16. The human capital management system of claim 13, wherein the toolkit is stored in memory on a mobile device.

17. The human capital management system of claim 13, wherein the additional software is stored on a computer.

18. A method for human capital management comprising:
displaying, on a video display, a toolkit for accessing a human capital or payroll database, thereby providing access to human capital or payroll data,
accessing, via the toolkit, a customized subset of the data stored in the human capital or payroll database for individualized purposes.

19. The method of claim 18 wherein the toolkit comprises a resource map that includes a display of search criteria and location markers on a graphical map for employees that meet the search criteria.

20. The method of claim 18 wherein the toolkit comprises a time-related display that includes a linear display of time with one or more event icon displayed along the linear display of time at a location visually mapped to the time that an event represented by the event icon occurs.

21. The method of claim 18 further comprising:
accessing, via a full-sized software application, the data stored in the human capital or payroll database.

22. The method of claim 21 wherein the toolkit and the full-sized software application are provided on the same device.

23. The method of claim 21 wherein the toolkit is provided on a roaming device and the full-sized software application is provided on a computer.

24. The method of claim 18 further comprising:
permitting a plurality of users to simultaneously access the toolkit, wherein a modification entered by a user accessing a form or data into the toolkit is visible to another user simultaneously accessing the form or data.
